(19) United States
(12) Patent Application Publication
(10) Pub. No.: US 2019/0319299 A1
(43) Pub. Date: Oct. 17, 2019

(54) ADVANCED ELECTROLYTE FOR HIGH VOLTAGE LITHIUM-ION BATTERIES

(71) Applicant: UChicago Argonne, LLC, Chicago, IL (US)

(72) Inventors: Khalil Amine, Oakbrook, IL (US); Chi Cheung Su, Westmont, IL (US); Meinan He, Willowbrook, IL (US); Zonghai Chen, Bolingbrook, IL (US)

(21) Appl. No.: 15/955,394

(22) Filed: Apr. 17, 2018

(51) Int. Cl. H01M 10/0525; H01M 10/04; H01M 10/0565; H01M 10/0569

(52) U.S. Cl. CPC H01M 10/0525; H01M 10/0431; H01M 2300/0022; H01M 10/0565; H01M 10/0569; H01M 10/0459

(57) ABSTRACT

A lithium ion battery includes a cathode having a voltage of greater than 4.1 V v. Li/Li⁺ and an aluminum or stainless steel current collector; an anode; a separator; and an electrolyte that includes a first salt that is a lithium sulfonylimide, a lithium sulfonate, or a mixture of any two or more thereof, and the first salt is present in the electrolyte from about 0.1 M to about 2 M; an aprotic solvent; and a second salt which suppresses corrosion of the aluminum or stainless steel current collector.

### GOVERNMENT RIGHTS

The United States Government has rights in this invention pursuant to Contract No. DE-AC02-06CH11357 between the U.S. Department of Energy and UChicago Argonne, LLC, representing Argonne National Laboratory.

### FIELD

The present technology is generally related to lithium rechargeable batteries. More particularly, the technology relates to the use non-aqueous electrolyte to enhance the stability of aluminum current collectors and other metallic cell components.

### BACKGROUND

Lithium-ion batteries are used extensively as electrical power for portable electronics and hybrid electric vehicles. To facilitate the application of pure electric vehicles, lithium-ion batteries with high energy density are essential. To increase the energy density of such batteries, new anode and cathode materials are being actively pursued. For example, silicon anodes are recognized as promising candidates due to their high theoretical capacity (4200 mAh/g). Furthermore, new high capacity cathode materials with higher operating voltages, such as Li₂FeSiO₄ and LiNiₓMn_{y}Co_{z}O₂, have been explored, where x, y, and z are from 0 to 1 and x+y+z=1.

However, higher operating voltages means more corrosive environments within the cell, and aluminum components are particularly susceptible. The corrosion may lower the Coulombic efficiency of the cell, and accelerate capacity fading of the battery. It is therefore of interest to the battery industry to identify new additives that will mitigate the corrosion of cell components to enable stable cycling with high Coulombic efficiency.

### SUMMARY

In one aspect, a lithium ion battery is provided including a cathode having a voltage of greater than 4.1 V v. Li/Li⁺ and an aluminum or stainless steel current collector; an anode; a separator; and an electrolyte. The electrolye includes first salt that is a lithium sulfonylimide, a lithium sulfonate, a lithium sulfonylmethide, or a mixture of any two or more thereof, and the first salt is present in the electrolyte from about 0.1 M to about 2 M; an aprotic solvent; and a second salt which suppresses corrosion of the aluminum or stainless steel current collector; wherein: the second salt is present in the electrolyte from about 0.1 wt % to about 10 wt %; and the second salt is a compound of Formula I, II, or III:

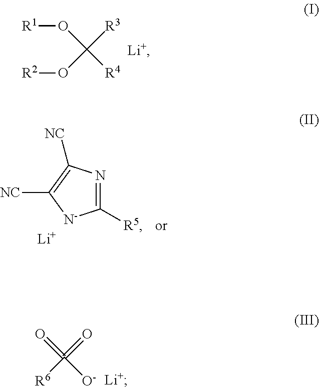

R¹ is alkyl, alkenyl, or alkynyl; R² is alkyl, alkenyl, or alkynyl; or R¹ and R² may join together to form a ring with the boron and oxygen atoms to which they are attached; R³ is F, Cl, Br, I, alkyl, or O-alkyl; R⁴ is F, Cl, Br, I, alkyl, or O-alkyl; or R³ and R⁴ may join together to form a ring with the boron atom to which they are attached; R⁵ is H, alkyl, alkenyl, alkynyl, or O-alkyl; and R⁶ is H, alkyl, alkenyl, or alkynyl. In some embodiments, the electrolyte is free of LiPF₆.

### BRIEF DESCRIPTION OF THE DRAWINGS

FIG. 1 is a discharge capacity vs. cycle number graph for Li/Silicon@graphite half-cell in the 2032 coin cells using 1.2M LiPF6 EC/EMC (3:7) with 10 wt % FEC electrolyte, LiFSI/EMC (1:1 in molar ratio) electrolyte and LiFSI/EMC 1:1 in molar ratio with 30% D2 as the co-solvent electrolyte. The cells were cycled from 0.05 V to 1.5 V at the rate of C/2, according to Example 3.

FIG. 2 is a graph of the Coulombic efficiency profiles for Li/Silicon@graphite half-cell in the 2032 coin cells using 1.2M LiPF6 EC/EMC (3:7) with 10 wt % FEC electrolyte, LiFSI/EMC (1:1 in molar ratio) electrolyte and LiFSI/EMC 1:1 in molar ratio with 30% D2 as the co-solvent electrolyte. The cells were cycled from 0.05 V to 1.5 V at the rate of C/2, according to Example 3.

FIG. 3 is a discharge capacity v. cycle number graph for LiNi_{0.6}Mn_{0.2}Co_{0.2}O₂/Li metal 2032 coin cells using LiFSI/EMC (1:1 in molar ratio) electrolyte and LiFSI/EMC 1:1 in molar ratio with 30% D2 as the co-solvent electrolyte. The cells were cycled from 2.8 V to 4.4 V at a current of C/3, according to Example 4.

FIG. 4 is a graph of the Coulombic efficiency profiles for LiNi_{0.6}Mn_{0.2}Co_{0.2}O₂/Li metal 2032 coin cells using LiFSI/EMC (1:1 in molar ratio) electrolyte and LiFSI/EMC 1:1 in molar ratio with 30% D2 as the co-solvent electrolyte. The cells were cycled from 2.8 V to 4.4 V at a current of C/3, according to Example 4.

FIG. 5 is a schematic of the Li/Al cell used for the potentiostatic hold experiments, according to Example 5.

FIG. 6 is a chronoamperogram of the Al/Li half-cell potentiostatic hold experiments result in LiFSI:EMC (1:4 molar ratio) electrolyte without/with 5% LiDFOB, LiTTFB or LiBMFMB as the additive under upper cutoff voltage from 3.6V to 4.6V, 10 hrs for each hold, according to Example 6.

FIG. 7 is a chronoamperogram of the Al/Li half-cell potentiostatic hold experiments result in LiFSI:EMC (1:4 molar ratio) electrolyte without/with 5% LiDFOB, LiTTFB or LiBMFMB as the additive under upper cutoff voltage from 3.6V to 4.1V, 10 hrs for each hold, according to Example 6.

FIG. 8 is a chronoamperogram of the Al/Li half-cell potentiostatic hold experiments result in LiFSI:EMC (1:4 molar ratio) electrolyte without/with 5% LiDFOB, LiNFBS or saturated LiBOB as the additive under upper cutoff voltage from 3.6V to 4.6V, 10 hrs for each hold, according to Example 7.

FIG. 9 is a chronoamperogram of the Al/Li half-cell potentiostatic hold experiments result in LiFSI:EMC (1:4 molar ratio) electrolyte without/with 5% LiDFOB, LiNFBS or saturated LiBOB as the additive under upper cutoff voltage from 3.6V to 4.2V, 10 hrs for each hold, according to Example 7.

FIG. 10 is a chronoamperogram of the Al/Li half-cell potentiostatic hold experiments result in LiFSI:EMC (1:4 molar ratio) electrolyte without/with 5% LiPF6, or saturated LiTDI as the additive under upper cutoff voltage from 3.6V to 4.6V, 10 hrs for each hold, according to example 8.

FIG. 11 is a chronoamperogram of the Al/Li half-cell potentiostatic hold experiments result in LiFSI:EMC (1:4 molar ratio) electrolyte without/with 5% LiPF6, or saturated LiTDI as the additive under upper cutoff voltage from 3.6V to 4.2V, 10 hrs for each hold, according to Example 8.

FIG. 12 is a linear oxidation sweep voltammogram of the cell with LiFSI:EMC (1:4 molar ratio) electrolyte without/with 1% LiTDI as the additive. The schematic of the Li/Li/Al cell used for the experiments is inserted, according to Example 9.

FIG. 13 is a discharge capacity vs. cycle number graph for Li/NCM523 half-cell in the 2032 coin cells using LiFSI:EMC (1:1.5 molar ratio) electrolyte without/with 1% LiBMFMB or 1% LiTDI as additive. The cells were cycled from 3.0 V to 4.1V at the rate of C/3, according to Example 10.

FIG. 14 is a graph of Coulombic efficiency profiles for Li/NCM523 half-cell in the 2032 coin cells using LiFSI:EMC (1:1.5 molar ratio) electrolyte without/with 1% LiBMFMB or 1% LiTDI as additive. The cells were cycled from 3.0 V to 4.1V at the rate of C/3, according to Example 10.

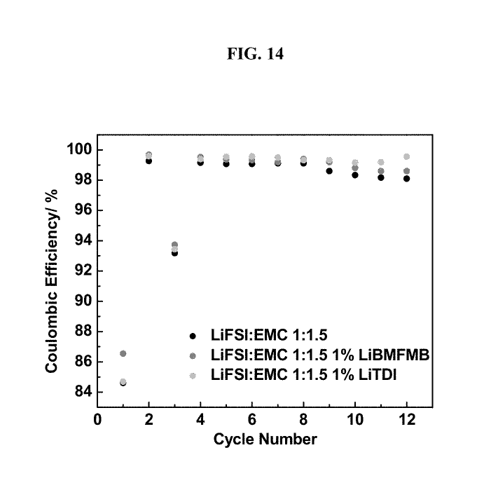

FIG. 15 is a discharge capacity vs. cycle number graph for Li/NCM523 half-cell in the 2032 coin cells using LiFSI:EMC (1:1.5 molar ratio) electrolyte without/with 2% LiTDI or 2% LiDFOB as additive. The cells were cycled from 3.0 V to 4.1V for the 1-10 cycles and 3.0-4.2V for the 11-21 cycles at the rate of C/3, according to Example 11.

FIG. 16 is a graph of Coulombic efficiency profiles for Li/NCM523 half-cell in the 2032 coin cells using LiFSI:EMC (1:1.5 molar ratio) electrolyte without/with 2% LiTDI or 2% LiDFOB as additive. The cells were cycled from 3.0 V to 4.1V for the 1-10 cycles and 3.0-4.2V for the 11-21 cycles at the rate of C/3, according to Example 11.

FIG. 17 is a discharge capacity vs. cycle number graph for Li/NCM523 half-cell in the 2032 coin cells using LiFSI:EMC (1:2.5 molar ratio) electrolyte without/with 1% LiTDI as additive. The cells were cycled from 3.0V to different upper cutoff voltage, 4.1V-4.5V and 10 cycles for each voltage under the rate of C/3, according to Example 12.

FIG. 18 is a graph of Coulombic efficiency profiles for half-cell in the 2032 coin cells using LiFSI:EMC (1:2.5 molar ratio) electrolyte without/with 1% LiTDI as an additive. The cells were cycled from 3.0V to different upper cutoff voltage, 4.1V-4.5V, and 10 cycles for each voltage under the rate of C/3, according to Example 12.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

It has now been found that in lithium ion batteries having an anode current collector, or in particular a cathode current collector, that is made of stainless steel, or, in particular, aluminum, where the electrolyte includes a corrosive salt such as LiPF₆. Accordingly, the present invention includes electrolytes, electrochemical cells, and methods of preventing, or at least minimizing the damage to the current collectors that may otherwise occur in current, state of the art systems.

In one aspect, an electrolyte is provided. The electrolyte includes a first salt that is a lithium sulfonylimide, a lithium sulfonate, a lithium sulfonylmethide or a mixture of any two or more thereof, and the first salt is present in the electrolyte from about 0.1 M to about 2 M; an aprotic solvent; and a second salt. In the electrolyte, the second salt is present from about 0.1 wt % to about 10 wt %; and the second salt is a compound represented by Formula I, II, or III:

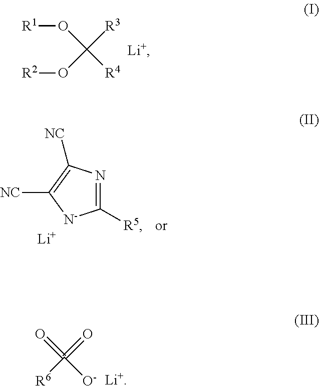

In the above formulae, R¹ is alkyl, alkenyl, alkynyl; R² is alkyl, alkenyl, alkynyl; or R¹ and R² may join together to form a ring with the boron and oxygen atoms to which they are attached; R³ is F, Cl, Br, I, alkyl, or O-alkyl; R⁴ is F, Cl, Br, I, alkyl, or O-alkyl; or R³ and R⁴ may join together to form a ring with the boron atom to which they are attached; R⁵ is H, alkyl, alkenyl, alkynyl, or O-alkyl; and R⁶ is H, alkyl, alkenyl, or alkynyl. In any of the embodiments described herein, the electrolyte or any device containing the electrolyte may be subject to the proviso that it is free of LiPF₆.

In any of the above embodiments, any of the alkyl, alkenyl, or alkynyl groups may be halogenated. For example, any of the alkyl groups may include a group of formula CₙHₓF_{y}, CH₂CₙHₓF_{y}, CH₂OCₙHₓF_{y}, or CF₂OCₙHₓF_{y}, wherein n is 1-5, x is 0 to 10, and y is 1 to 11. Illustrative alkyl groups include, but are not limited to, —CH₃, —CH₂CH₃. —CH₂CH₂CH₃, —CH(CH₃)₂, —CH₂CH₂CH₂CH₃, —CFH₂; —CF₂H; —CF₃; —CF₂CF₃; —CF₂CHF₂; —CF₂CH₃; —CF₂CH₂F; —CHFCF₃; —CHFCHF₂; —CHFCH₃; —CHFCH₂F; —CH₂CF₃; —CH₂CHF₂; —CH₂CH₂F; —CF(CF₃)₂; —CH(CF₃)₂; —CF₂CF₂CF₃; —CF₂CF₂CHF₂; —CF₂CF₂CH₃; —CF₂CF₂CH₂F; —CH₂CF₂CF₃; —CH₂CF₂CHF₂; —CH₂CF₂CH₃; —CH₂CF₂CH₂F; —CHFCF₂CF₃; —CHFCF₂CHF₂; —CHFCF₂CH₃; —CHFCF₂CH₂F; —CF₂CH₂CF₃; —CF₂CH₂CHF₂; —CF₂CH₂CH₃; —CF₂CH₂CH₂F; —CF₂CHFCF₃; —CF₂CHFCHF₂; —CF₂CHFCH₃; —CF₂CHFCH₂F; —CHFCHFCF₃; —CHFCHFCHF₂; —CHFCHFCH₃; —CHFCHFCH₂F; CH₂CH₂CF₃; —CH₂CH₂CHF₂; —CH₂CH₂CH₂F; —CF₂CF₂CF₂CF₃; —CF₂CF₂CF₂CH₃; —CF₂CF₂CF₂CHF₂; —CF₂CF₂CF₂CH₂F; —CH₂CF₂CF₂CF₃; —CH₂CF₂CF₂CH₃; —CH₂CF₂CF₂CHF₂; —CH₂CF₂CF₂CH₂F; —CHFCF₂CF₂CF₃; —CHFCF₂CF₂CH₃; —CHFCF₂CF₂CHF₂; —CHFCF₂CF₂CH₂F; —CF₂CH₂CF₂CF₃; —CF₂CH₂CF₂CH₃; —CF₂CH₂CF₂CHF₂; —CF₂CH₂CF₂CH₂F; —CF₂CHFCF₂CF₃; —CF₂CHFCF₂CH₃; —CF₂CHFCF₂CHF₂; —CF₂CHFCF₂CH₂F; —CHFCHFCF₂CF₃; —CHFCHFCF₂CH₃; —CHFCHFCF₂CHF₂; —CHFCHFCF₂CH₂F; —CH₂CH₂CF₂CF₃; —CH₂CH₂CF₂CH₃; —CH₂CH₂CF₂CHF₂; —CH₂CH₂CF₂CH₂F; —CF₂CF₂CF₂CF₂CF₃; —CH₂CF₂CF₂CF₂CF₃; —CF₂CF₂ CF₂CF₂CHF₂; —CH₂CF₂CF₂CF₂CHF₂; —CF₂OCFH₂; —CF₂OCF₂H; —CF₂OCF₃; —CF₂OCF₂CF₃; —CF₂OCF₂CHF₂; —CF₂OCF₂CH₃; —CF₂OCF₂CH₂F; —CF₂OCHFCF₃; —CF₂OCHFCHF₂; —CF₂OCHFCH₃; —CF₂OCHFCH₂F; —CF₂OCH₂CF₃; —CF₂OCH₂CHF₂; —CF₂OCH₂CH₂F; —CH₂OCFH₂; —CH₂OCF₂H; —CH₂OCF₃; —CH₂OCF₂CF₃; —CH₂OCF₂CHF₂; —CH₂OCF₂CH₃; —CH₂OCF₂CH₂F; —CH₂OCHFCF₃; —CH₂OCHFCHF₂; —CH₂OCHFCH₃; —CH₂OCHFCH₂F; —CH₂OCH₂CF₃; —CH₂OCH₂CHF₂; —CH₂OCH₂CH₂F; —CHFOCFH₂; —CHFOCF₂H; —CHFOCF₃; —CHFOCF₂CF₃; —CHFOCF₂CHF₂; —CHFOCF₂CH₃; —CHFOCF₂CH₂F; —CHFOCHFCF₃; —CHFOCHFCHF₂; —CHFOCHFCH₃; —CHFOCHFCH₂F; —CHFOCH₂CF₃; —CHFOCH₂CHF₂; or —CHFOCH₂CH₂F.

In any of the above embodiments, the second salt may be a compound of Formula I, and wherein R¹ and R² are haloalkyl or they join together to form a ring; and R³ and R⁴ are F, O-haloalkyl, or they join together to form a ring. In some embodiments, the second salt the second salt may be represented as a compound of Formula I, and is Li[B(O(CH₂)ₓCF₃)₄] where x is 1, 2, 3, 4, 5, or 6;

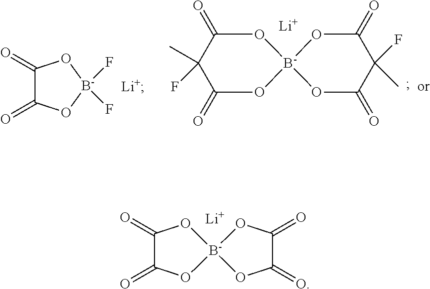

In some embodiments, the second salt may be represented as a compound of Formula II, and is C

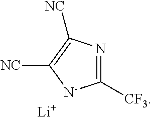 [SMILES: N#Cc1nc(C(F)(F)F)[n-]c1C#N ; [Li+]]

In some embodiments, the second salt may be represented as a compound of Formula III, and is

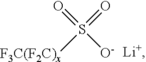

where x is 1, 2, 3, 4, 5, or 6.

In any of the above embodiments, the electrolyte may further include Li₂(B₁₂X_{12-q}Hₐ), Li₂(B₁₀X_{10-q′}H_{q′}), or a mixture of any two or more thereof, wherein X is independently at each occurrence a halogen, q is an integer from 0 to 12, and q′ is an integer from 0 to 10.

As noted above, the electrolytes include a lithium sulfonylimide, a lithium sulfonate, or a mixture of any two or more thereof. Where the electrolyte includes the lithium sulfonylimide it may be a compound represented as formula:

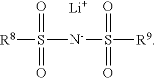

In the above Formula, R⁸ and R⁹ may be individually F, alkyl, haloalkyl, aryl, or haloaryl. In some embodiments, the haloalkyl or haloaryl are fluoroalkyl and fluoroaryl, respectively. Illustrative alkyl groups includes, but are not limited to, groups of formula CₙHₓF_{y}, CH₂CₙHₓF_{y}, CH₂OCₙHₓF_{y}, or CF₂OCₙHₓF_{y}, wherein n is 1-5, x is 0 to 10, and y is 1 to 11. Illustrative alkyl groups include, but are not limited to, —CH₃, —CH₂CH₃. —CH₂CH₂CH₃, —CH(CH₃)₂, —CH₂CH₂CH₂CH₃, —CFH₂; —CF₂H; —CF₃; —CF₂CF₃; —CF₂CHF₂; —CF₂CH₃; —CF₂CH₂F; —CHFCF₃; —CHFCHF₂; —CHFCH₃; —CHFCH₂F; —CH₂CF₃; —CH₂CHF₂; —CH₂CH₂F; —CF(CF₃)₂; —CH(CF₃)₂; —CF₂CF₂CF₃; —CF₂CF₂CHF₂; —CF₂CF₂CH₃; —CF₂CF₂CH₂F; —CH₂CF₂CF₃; —CH₂CF₂CHF₂; —CH₂CF₂CH₃; —CH₂CF₂CH₂F; —CHFCF₂CF₃; —CHFCF₂CHF₂; —CHFCF₂CH₃; —CHFCF₂CH₂F; —CF₂CH₂CF₃; —CF₂CH₂CHF₂; —CF₂CH₂CH₃; —CF₂CH₂CH₂F; —CF₂CHFCF₃; —CF₂CHFCHF₂; —CF₂CHFCH₃; —CF₂CHFCH₂F; —CHFCHFCF₃; —CHFCHFCHF₂; —CHFCHFCH₃; —CHFCHFCH₂F; CH₂CH₂CF₃; —CH₂CH₂CHF₂; —CH₂CH₂CH₂F; —CF₂CF₂CF₂CF₃; —CF₂CF₂CF₂CH₃; —CF₂CF₂CF₂CHF₂; —CF₂CF₂CF₂CH₂F; —CH₂CF₂CF₂CF₃; —CH₂CF₂CF₂CH₃; —CH₂CF₂CF₂CHF₂; —CH₂CF₂CF₂CH₂F; —CHFCF₂CF₂CF₃; —CHFCF₂CF₂CH₃; —CHFCF₂CF₂CHF₂; —CHFCF₂CF₂CH₂F; —CF₂CH₂CF₂CF₃; —CF₂CH₂CF₂CH₃; —CF₂CH₂CF₂CHF₂; —CF₂CH₂CF₂CH₂F; —CF₂CHFCF₂CF₃; —CF₂CHFCF₂CH₃; —CF₂CHFCF₂CHF₂; —CF₂CHFCF₂CH₂F; —CHFCHFCF₂CF₃; —CHFCHFCF₂CH₃; —CHFCHFCF₂CHF₂; —CHFCHFCF₂CH₂F; —CH₂CH₂CF₂CF₃; —CH₂CH₂CF₂CH₃; —CH₂CH₂CF₂CHF₂; —CH₂CH₂CF₂CH₂F; —CF₂CF₂CF₂CF₂CF₃; —CH₂CF₂CF₂CF₂CF₃; —CF₂CF₂CF₂ CF₂CHF₂; —CH₂CF₂CF₂CF₂CHF₂; —CF₂OCFH₂; —CF₂OCF₂H; —CF₂OCF₃; —CF₂OCF₂CF₃; —CF₂OCF₂CHF₂; —CF₂OCF₂CH₃; —CF₂OCF₂CH₂F; —CF₂OCHFCF₃; —CF₂OCHFCHF₂; —CF₂OCHFCH₃; —CF₂OCHFCH₂F; —CF₂OCH₂CF₃; —CF₂OCH₂CHF₂; —CF₂OCH₂CH₂F; —CH₂OCFH₂; —CH₂OCF₂H; —CH₂OCF₃; —CH₂OCF₂CF₃; —CH₂OCF₂CHF₂; —CH₂OCF₂CH₃; —CH₂OCF₂CH₂F; —CH₂OCHFCF₃; —CH₂OCHFCHF₂; —CH₂OCHFCH₃; —CH₂OCHFCH₂F; —CH₂OCH₂CF₃; —CH₂OCH₂CHF₂; —CH₂OCH₂CH₂F; —CHFOCFH₂; —CHFOCF₂H; —CHFOCF₃; —CHFOCF₂CF₃; —CHFOCF₂CHF₂; —CHFOCF₂CH₃; —CHFOCF₂CH₂F; —CHFOCHFCF₃; —CHFOCHFCHF₂; —CHFOCHFCH₃; —CHFOCHFCH₂F; —CHFOCH₂CF₃; —CHFOCH₂CHF₂; or —CHFOCH₂CH₂F. In some embodiments, the lithium sulfonimide is lithium bis-fluoromethanesulfonimide.

Where the electrolyte includes the lithium sulfonate it may be a compound represented as formula:

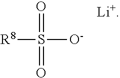

In the above formula, R⁸ may be F, alkyl, haloalkyl, aryl, or haloaryl. In some embodiments, the haloalkyl or haloaryl are fluoroalkyl and fluoroaryl, respectively. Illustrative alkyl groups includes, but are not limited to, groups of formula CₙHₓF_{y}, CH₂CₙHₓF_{y}, CH₂OCₙHₓF_{y}, or CF₂OCₙHₓF_{y}, wherein n is 1-5, x is 0 to 10, and y is 1 to 11. Illustrative alkyl groups include, but are not limited to, —CH₃, —CH₂CH₃. —CH₂CH₂CH₃, —CH(CH₃)₂, —CH₂CH₂CH₂CH₃, —CFH₂; —CF₂H; —CF₃; —CF₂CF₃; —CF₂CHF₂; —CF₂CH₃; —CF₂CH₂F; —CHFCF₃; —CHFCHF₂; —CHFCH₃; —CHFCH₂F; —CH₂CF₃; —CH₂CHF₂; —CH₂CH₂F; —CF(CF₃)₂; —CH(CF₃)₂; —CF₂CF₂CF₃; —CF₂CF₂CHF₂; —CF₂CF₂CH₃; —CF₂CF₂CH₂F; —CH₂CF₂CF₃; —CH₂CF₂CHF₂; —CH₂CF₂CH₃; —CH₂CF₂CH₂F; —CHFCF₂CF₃; —CHFCF₂CHF₂; —CHFCF₂CH₃; —CHFCF₂CH₂F; —CF₂CH₂CF₃; —CF₂CH₂CHF₂; —CF₂CH₂CH₃; —CF₂CH₂CH₂F; —CF₂CHFCF₃; —CF₂CHFCHF₂; —CF₂CHFCH₃; —CF₂CHFCH₂F; —CHFCHFCF₃; —CHFCHFCHF₂; —CHFCHFCH₃; —CHFCHFCH₂F; CH₂CH₂CF₃; —CH₂CH₂CHF₂; —CH₂CH₂CH₂F; —CF₂CF₂CF₂CF₃; —CF₂CF₂CF₂CH₃; —CF₂CF₂CF₂CHF₂; —CF₂CF₂CF₂CH₂F; —CH₂CF₂CF₂CF₃; —CH₂CF₂CF₂CH₃; —CH₂CF₂CF₂CHF₂; —CH₂CF₂CF₂CH₂F; —CHFCF₂CF₂CF₃; —CHFCF₂CF₂CH₃; —CHFCF₂CF₂CHF₂; —CHFCF₂CF₂CH₂F; —CF₂CH₂CF₂CF₃; —CF₂CH₂CF₂CH₃; —CF₂CH₂CF₂CHF₂; —CF₂CH₂CF₂CH₂F; —CF₂CHFCF₂CF₃; —CF₂CHFCF₂CH₃; —CF₂CHFCF₂CHF₂; —CF₂CHFCF₂CH₂F; —CHFCHFCF₂CF₃; —CHFCHFCF₂CH₃; —CHFCHFCF₂CHF₂; —CHFCHFCF₂CH₂F; —CH₂CH₂CF₂CF₃; —CH₂CH₂CF₂CH₃; —CH₂CH₂CF₂CHF₂; —CH₂CH₂CF₂CH₂F; —CF₂CF₂CF₂CF₂CF₃; —CH₂CF₂CF₂CF₂CF₃; —CF₂CF₂CF₂ CF₂CHF₂; —CH₂CF₂CF₂CF₂CHF₂; —CF₂OCFH₂; —CF₂OCF₂H; —CF₂OCF₃; —CF₂OCF₂CF₃; —CF₂OCF₂CHF₂; —CF₂OCF₂CH₃; —CF₂OCF₂CH₂F; —CF₂OCHFCF₃; —CF₂OCHFCHF₂; —CF₂OCHFCH₃; —CF₂OCHFCH₂F; —CF₂OCH₂CF₃; —CF₂OCH₂CHF₂; —CF₂OCH₂CH₂F; —CH₂OCFH₂; —CH₂OCF₂H; —CH₂OCF₃; —CH₂OCF₂CF₃; —CH₂OCF₂CHF₂; —CH₂OCF₂CH₃; —CH₂OCF₂CH₂F; —CH₂OCHFCF₃; —CH₂OCHFCHF₂; —CH₂OCHFCH₃; —CH₂OCHFCH₂F; —CH₂OCH₂CF₃; —CH₂OCH₂CHF₂; —CH₂OCH₂CH₂F; —CHFOCFH₂; —CHFOCF₂H; —CHFOCF₃; —CHFOCF₂CF₃; —CHFOCF₂CHF₂; —CHFOCF₂CH₃; —CHFOCF₂CH₂F; —CHFOCHFCF₃; —CHFOCHFCHF₂; —CHFOCHFCH₃; —CHFOCHFCH₂F; —CHFOCH₂CF₃; —CHFOCH₂CHF₂; or —CHFOCH₂CH₂F. In some embodiments, the lithium sulfonate is lithium trifluoromethanesulfonate, lithium methanesulfonate, lithium pentafluorobenzenesulfonate, lithium benzenesulfonate, lithium tosylate, lithium pentafluoroethanesulfonate, or lithium tetrafluoroethanesulfonate.

Where the electrolyte includes the lithium sulfonylmethide it may be a compound represented as formula:

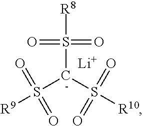

In the above formula, R⁸, R⁹, and R¹⁰ are individually F, alkyl, haloalkyl, aryl, or haloaryl. In some embodiments, the haloalkyl or haloaryl are fluoroalkyl and fluoroaryl, respectively. Illustrative alkyl groups includes, but are not limited to, groups of formula CₙHₓF_{y}, CH₂CₙHₓF_{y}, CH₂OCₙHₓF_{y}, or CF₂OCₙHₓF_{y}, wherein n is 1-5, x is 0 to 10, and y is 1 to 11. Illustrative alkyl groups include, but are not limited to, —CH₃, —CH₂CH₃. —CH₂CH₂CH₃, —CH(CH₃)₂, —CH₂CH₂CH₂CH₃, —CFH₂; —CF₂H; —CF₃; —CF₂CF₃; —CF₂CHF₂; —CF₂CH₃; —CF₂CH₂F; —CHFCF₃; —CHFCHF₂; —CHFCH₃; —CHFCH₂F; —CH₂CF₃; —CH₂CHF₂; —CH₂CH₂F; —CF(CF₃)₂; —CH(CF₃)₂; —CF₂CF₂CF₃; —CF₂CF₂CHF₂; —CF₂CF₂CH₃; —CF₂CF₂CH₂F; —CH₂CF₂CF₃; —CH₂CF₂CHF₂; —CH₂CF₂CH₃; —CH₂CF₂CH₂F; —CHFCF₂CF₃; —CHFCF₂CHF₂; —CHFCF₂CH₃; —CHFCF₂CH₂F; —CF₂CH₂CF₃; —CF₂CH₂CHF₂; —CF₂CH₂CH₃; —CF₂CH₂CH₂F; —CF₂CHFCF₃; —CF₂CHFCHF₂; —CF₂CHFCH₃; —CF₂CHFCH₂F; —CHFCHFCF₃; —CHFCHFCHF₂; —CHFCHFCH₃; —CHFCHFCH₂F; CH₂CH₂CF₃; —CH₂CH₂CHF₂; —CH₂CH₂CH₂F; —CF₂CF₂CF₂CF₃; —CF₂CF₂CF₂CH₃; —CF₂CF₂CF₂CHF₂; —CF₂CF₂CF₂CH₂F; —CH₂CF₂CF₂CF₃; —CH₂CF₂CF₂CH₃; —CH₂CF₂CF₂CHF₂; —CH₂CF₂CF₂CH₂F; —CHFCF₂CF₂CF₃; —CHFCF₂CF₂CH₃; —CHFCF₂CF₂CHF₂; —CHFCF₂CF₂CH₂F; —CF₂CH₂CF₂CF₃; —CF₂CH₂CF₂CH₃; —CF₂CH₂CF₂CHF₂; —CF₂CH₂CF₂CH₂F; —CF₂CHFCF₂CF₃; —CF₂CHFCF₂CH₃; —CF₂CHFCF₂CHF₂; —CF₂CHFCF₂CH₂F; —CHFCHFCF₂CF₃; —CHFCHFCF₂CH₃; —CHFCHFCF₂CHF₂; —CHFCHFCF₂CH₂F; —CH₂CH₂CF₂CF₃; —CH₂CH₂CF₂CH₃; —CH₂CH₂CF₂CHF₂; —CH₂CH₂CF₂CH₂F; —CF₂CF₂CF₂CF₂CF₃; —CH₂CF₂CF₂CF₂CF₃; —CF₂CF₂CF₂ CF₂CHF₂; —CH₂CF₂CF₂CF₂CHF₂; —CF₂OCFH₂; —CF₂OCF₂H; —CF₂OCF₃; —CF₂OCF₂CF₃; —CF₂OCF₂CHF₂; —CF₂OCF₂CH₃; —CF₂OCF₂CH₂F; —CF₂OCHFCF₃; —CF₂OCHFCHF₂; —CF₂OCHFCH₃; —CF₂OCHFCH₂F; —CF₂OCH₂CF₃; —CF₂OCH₂CHF₂; —CF₂OCH₂CH₂F; —CH₂OCFH₂; —CH₂OCF₂H; —CH₂OCF₃; —CH₂OCF₂CF₃; —CH₂OCF₂CHF₂; —CH₂OCF₂CH₃; —CH₂OCF₂CH₂F; —CH₂OCHFCF₃; —CH₂OCHFCHF₂; —CH₂OCHFCH₃; —CH₂OCHFCH₂F; —CH₂OCH₂CF₃; —CH₂OCH₂CHF₂; —CH₂OCH₂CH₂F; —CHFOCFH₂; —CHFOCF₂H; —CHFOCF₃; —CHFOCF₂CF₃; —CHFOCF₂CHF₂; —CHFOCF₂CH₃; —CHFOCF₂CH₂F; —CHFOCHFCF₃; —CHFOCHFCHF₂; —CHFOCHFCH₃; —CHFOCHFCH₂F; —CHFOCH₂CF₃; —CHFOCH₂CHF₂; or —CHFOCH₂CH₂F. In some embodiments, the lithium

The solvent of the electrolyte is an aprotic solvent that may be a linear carbonate, an ether, a cyclic carbonate, an amide, an ester, a nitrile, a cyclic ester, a sulfone, or an ionic liquid. The electrolyte may include gelling materials such that an aprotic gel is present as well. In some embodiments, the aprotic solvent may include a cation that is a pyrrolidinium-based ionic liquid, a piperidinium-based ionic liquid, a imidazolium-based ionic liquid, an ammonium-based ionic liquid, a phosphonium-based ionic liquid, a cyclic phosphonium-based ionic liquid, or a sulfonium-based ionic liquid. The ionic liquids may an anion that is N(CF₃SO₂)₂⁻, N(FSO₂)₂⁻, N(CF₃CF₂SO₂)₂⁻, C(CF₃SO₂)₃⁻, CF₃SO₃⁻, CF₃CO₂⁻, N(CN)₂⁻, or C₂F₅CO₂⁻. Illustrative ionic liquids include, but are not limited to, 1-ethyl-3-methyl-imidazolium bis(trifluoromethanesulfonyl)imide, 1-ethyl-3-methyl-imidazolium bis(fluorosulfonyl)imide, 1-ethyl-2,3-dimethyl-imidazolium bis(trifluoromethanesulfonyl)imide, 1-ethyl-2,3-dimethyl-imidazolium bis(fluorosulfonyl)imide, 1-methyl-3-ethyl-imidazolium bis(trifluoromethanesulfonyl)imide, 1-methyl-3-ethyl-imidazolium bis(fluorosulfonyl)imide, 1-ethyl-3-(2-methoxyethoxymethyl)-1H-imidazol-3-ium bis(trifluoromethanesulfonyl)imide, 1-ethyl-3-(2-methoxyethoxymethyl)-1H-imidazol-3-ium bis(fluorosulfonyl)imide, 1-n-butyl-3-methyl-imidazolium bis(trifluoromethanesulfonyl)imide, 1-n-butyl-3-methyl-imidazolium bis(fluorosulfonyl)imide, 3-ethyl-1-(2-methoxyethyl)-1H-imidazol-3-ium bis(trifluoromethanesulfonyl)imide, 3-ethyl-1-(2-methoxyethyl)-1H-imidazol-3-ium bis(fluorosulfonyl)imide; pyrrolidinium salts such as 1-butyl-1-methylpyrrolidinium bis(trifluoromethanesulfonyl)imide, 1-butyl-1-methylpyrrolidinium bis(fluorosulfonyl)imide, 1-ethyl-1-methylpyrrolidinium bis(trifluoromethanesulfonyl)imide, 1-ethyl-1-methylpyrrolidinium bis(fluorosulfonyl)imide, 1-methyl-1-propylpyrrolidinium bis(trifluoromethanesulfonyl)imide, 1-methyl-1-propylpyrrolidinium bis(fluorosulfonyl)imide, 1-(2-methoxyethyl)-1-ethylpyrrolidinium bis(trifluoromethanesulfonyl)imide, 1-(2-methoxyethyl)-1-ethylpyrrolidinium bis(fluorosulfonyl)imide; piperidinium salts such as 1-butyl-1-methylpiperidinium bis(trifluoromethanesulfonyl)imide, 1-butyl-1-methylpiperidinium bis(fluorosulfonyl)imide, 1-methyl-1-propyl piperidinium bis(trifluoromethanesulfonyl)imide, 1-methyl-1-propyl piperidinium bis(fluorosulfonyl)imide, 1-(2-methoxyethyl)-1-ethylpiperidinium bis(trifluoromethanesulfonyl)imide, 1-(2-methoxyethyl)-1-ethylpiperidinium bis(fluorosulfonyl)imide; phosphonium salts such as triethyl(2-methoxyethyl)phosphonium bis(trifluoromethanesulfonyl)imide, triethyl(2-methoxyethyl)phosphonium bis(fluorosulfonyl)imide, tripropyl(2-methoxyethyl)phosphonium bis(trifluoromethanesulfonyl)imide, tripropyl(2-methoxyethyl)phosphonium bis(fluorosulfonyl)imide, tributyl(2-methoxyethyl)phosphonium bis(trifluoromethanesulfonyl)imide, tributyl(2-methoxyethyl)phosphonium bis(fluorosulfonyl)imide, tetraethylphosphonium bis(trifluoromethanesulfonyl)imide, tetraethylphosphonium bis(fluorosulfonyl)imide, tetrabutylphosphonium bis(trifluoromethanesulfonyl)imide, tetrabutylphosphonium bis(fluorosulfonyl)imide, tributylmethylphosphonium bis(trifluoromethanesulfonyl)imide, tributylmethylphosphonium bis(fluorosulfonyl)imide, triethylbutylphosphonium bis(trifluoromethanesulfonyl)imide, triethylbutylphosphonium bis(fluorosulfonyl)imide, or a mixture of any two or more thereof.

In some embodiments, the aprotic solvent may be an organic carbonate, fluorinated carbonate, ether, fluorinated ether, glyme, sulfone, organic sulfate, ester, cyclic ester, fluorinated ester, nitrile, amide, dinitrile, fluorinated amide, carbamate, fluorinated carbamate, or a cyanoester. Illustrative aprotic solvents include, but are not limited to, ethylene carbonate, fluoroethylene carbonate, 4-(trifluoromethyl)-1,3-dioxolan-2-one, propylene carbonate, dimethyl carbonate, ethyl methyl carbonate, diethyl carbonate, methyl propyl carbonate, ethyl propyl carbonate, dipropyl carbonate, bis(trifluoroethyl) carbonate, bis(pentafluoropropyl) carbonate, trifluoroethyl methyl carbonate, pentafluoroethyl methyl carbonate, trifluoroethyl ethyl carbonate, heptafluoropropyl ethyl carbonate, hexafluoroisopropyl methyl carbonate, pentafluoroethyl ethyl carbonate, pentafluorobutyl methyl carbonate, pentafluorobutyl ethyl carbonate, dimethoxyethane, triglyme, dimethyl ether, diglyme, tetraglyme, dimethyl ethylene carbonate, ethyl acetate, trifluoroethyl acetate, ethyl methyl sulfone, sulfolane, methyl isopropyl sulfone, butyrolactone, acetonitrile, succinonitrile, methyl 2-cyanoacetate, N,N-dimethylacetamide, 2,2,2-trifluoro-N,N-dimethylacetamide, methyl dimethylcarbamate, 2,2,2-trifluoroethyl dimethylcarbamate, and mixtures of any two or more thereof.

In another aspect, a lithium ion battery is provided and includes a cathode having a voltage of greater than 4.1 V v. Li/Li⁺ and an aluminum or stainless steel current collector, an anode, a separator, and an electrolyte. The electrolyte includes a first salt that is a lithium sulfonylimide, a lithium sulfonate, or a mixture of any two or more thereof, and the first salt is present in the electrolyte from about 0.1 M to about 2 M; an aprotic solvent; and a second salt which suppresses corrosion of the aluminum or stainless steel current collector. In the electrolyte, the second salt is present from about 0.1 wt % to about 10 wt %; and the second salt is a compound represented by Formula I, II, or III:

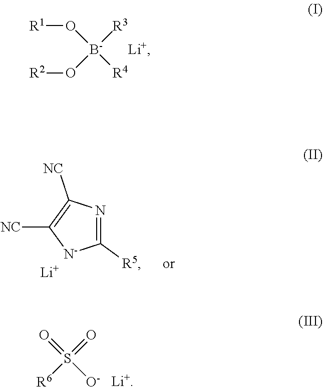

In the above formulae, R¹ is alkyl, alkenyl, alkynyl; R² is alkyl, alkenyl, alkynyl; or R¹ and R² may join together to form a ring with the boron and oxygen atoms to which they are attached; R³ is F, Cl, Br, I, alkyl, or O-alkyl; R⁴ is F, Cl, Br, I, alkyl, or O-alkyl; or R³ and R⁴ may join together to form a ring with the boron atom to which they are attached; R⁵ is H, alkyl, alkenyl, alkynyl, or O-alkyl; and R⁶ is H, alkyl, alkenyl, or alkynyl. In any of the embodiments described herein, the electrolyte or any device containing the electrolyte may be subject to the proviso that it is free of LiPF₆.

In any of the above embodiments, any of the alkyl, alkenyl, or alkynyl groups may be halogenated. For example, any of the alkyl groups may include a group of formula CₙHₓF_{y}, CH₂CₙHₓF_{y}, CH₂OCₙHₓF_{y}, or CF₂OCₙHₓF_{y}, wherein n is 1-5, x is 0 to 10, and y is 1 to 11. Illustrative alkyl groups include, but are not limited to, —CH₃, —CH₂CH₃. —CH₂CH₂CH₃, —CH(CH₃)₂, —CH₂CH₂CH₂CH₃, —CFH₂; —CF₂H; —CF₃; —CF₂CF₃; —CF₂CHF₂; —CF₂CH₃; —CF₂CH₂F; —CHFCF₃; —CHFCHF₂; —CHFCH₃; —CHFCH₂F; —CH₂CF₃; —CH₂CHF₂; —CH₂CH₂F; —CF(CF₃)₂; —CH(CF₃)₂; —CF₂CF₂CF₃; —CF₂CF₂CHF₂; —CF₂CF₂CH₃; —CF₂CF₂CH₂F; —CH₂CF₂CF₃; —CH₂CF₂CHF₂; —CH₂CF₂CH₃; —CH₂CF₂CH₂F; —CHFCF₂CF₃; —CHFCF₂CHF₂; —CHFCF₂CH₃; —CHFCF₂CH₂F; —CF₂CH₂CF₃; —CF₂CH₂CHF₂; —CF₂CH₂CH₃; —CF₂CH₂CH₂F; —CF₂CHFCF₃; —CF₂CHFCHF₂; —CF₂CHFCH₃; —CF₂CHFCH₂F; —CHFCHFCF₃; —CHFCHFCHF₂; —CHFCHFCH₃; —CHFCHFCH₂F; CH₂CH₂CF₃; —CH₂CH₂CHF₂; —CH₂CH₂CH₂F; —CF₂CF₂CF₂CF₃; —CF₂CF₂CF₂CH₃; —CF₂CF₂CF₂CHF₂; —CF₂CF₂CF₂CH₂F; —CH₂CF₂CF₂CF₃; —CH₂CF₂CF₂CH₃; —CH₂CF₂CF₂CHF₂; —CH₂CF₂CF₂CH₂F; —CHFCF₂CF₂CF₃; —CHFCF₂CF₂CH₃; —CHFCF₂CF₂CHF₂; —CHFCF₂CF₂CH₂F; —CF₂CH₂CF₂CF₃; —CF₂CH₂CF₂CH₃; —CF₂CH₂CF₂CHF₂; —CF₂CH₂CF₂CH₂F; —CF₂CHFCF₂CF₃; —CF₂CHFCF₂CH₃; —CF₂CHFCF₂CHF₂; —CF₂CHFCF₂CH₂F; —CHFCHFCF₂CF₃; —CHFCHFCF₂CH₃; —CHFCHFCF₂CHF₂; —CHFCHFCF₂CH₂F; —CH₂CH₂CF₂CF₃; —CH₂CH₂CF₂CH₃; —CH₂CH₂CF₂CHF₂; —CH₂CH₂CF₂CH₂F; —CF₂CF₂CF₂CF₂CF₃; —CH₂CF₂CF₂CF₂CF₃; —CF₂CF₂CF₂ CF₂CHF₂; —CH₂CF₂CF₂CF₂CHF₂; —CF₂OCFH₂; —CF₂OCF₂H; —CF₂OCF₃; —CF₂OCF₂CF₃; —CF₂OCF₂CHF₂; —CF₂OCF₂CH₃; —CF₂OCF₂CH₂F; —CF₂OCHFCF₃; —CF₂OCHFCHF₂; —CF₂OCHFCH₃; —CF₂OCHFCH₂F; —CF₂OCH₂CF₃; —CF₂OCH₂CHF₂; —CF₂OCH₂CH₂F; —CH₂OCFH₂; —CH₂OCF₂H; —CH₂OCF₃; —CH₂OCF₂CF₃; —CH₂OCF₂CHF₂; —CH₂OCF₂CH₃; —CH₂OCF₂CH₂F; —CH₂OCHFCF₃; —CH₂OCHFCHF₂; —CH₂OCHFCH₃; —CH₂OCHFCH₂F; —CH₂OCH₂CF₃; —CH₂OCH₂CHF₂; —CH₂OCH₂CH₂F; —CHFOCFH₂; —CHFOCF₂H; —CHFOCF₃; —CHFOCF₂CF₃; —CHFOCF₂CHF₂; —CHFOCF₂CH₃; —CHFOCF₂CH₂F; —CHFOCHFCF₃; —CHFOCHFCHF₂; —CHFOCHFCH₃; —CHFOCHFCH₂F; —CHFOCH₂CF₃; —CHFOCH₂CHF₂; or —CHFOCH₂CH₂F.

In any of the above embodiments, the second salt may be a compound of Formula I, and wherein R¹ and R² are haloalkyl or they join together to form a ring; and R³ and R⁴ are F, O-haloalkyl, or they join together to form a ring. In some embodiments, the second salt the second salt may be represented as a compound of Formula I, and is Li[B(O(CH₂)ₓCF₃)₄] where x is 1, 2, 3, 4, 5, or 6;

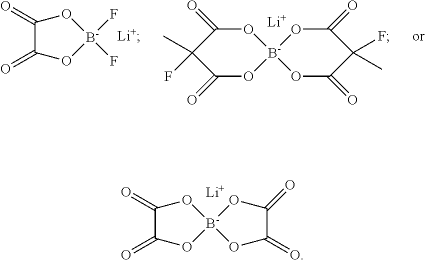

In some embodiments, the second salt may be represented as a compound of Formula II, and is

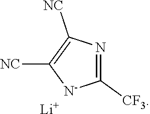 [SMILES: N#Cc1nc(C(F)(F)F)[n-]c1C#N ; [Li+]]

In some embodiments, the second salt may be represented as a compound of Formula III, and is

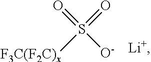

where x is 1, 2, 3, 4, 5, or 6.

In some embodiments, the second salt may be lithium difluoro(oxalato)borate (LiDFOB), lithium bis(oxalato)borate (LiBOB), lithium 4,5-dicyano-2-(trifluoromethyl)imidazol-1-ide (LiTDI), lithium perfluorobutanesulfonate (LiNFBS), lithium perfluoroalkanesulfonate, lithium tetrakis(2,2,2-trifluoroethoxy)borate (LiTTFB), lithium tetrakis(alkoxy)borate, lithium 2,4,8,10-tetraoxo-1,5,7,11-tetraoxa-6-boraspiro[5.5]undecan-6-uide, lithium 3,9-dimethyl-2,4,8,10-tetraoxo-1,5,7,11-tetraoxa-6-boraspiro[5.5]undecan-6-uide, lithium 3,9-difluoro-2,4,8,10-tetraoxo-1,5,7,11-tetraoxa-6-boraspiro[5.5]undecan-6-uide, lithium 3,9-difluoro-3,9-dimethyl-2,4,8,10-tetraoxo-1,5,7,11-tetraoxa-6-boraspiro[5.5]undecan-6-uide (LiBMFMB), or a mixture of any two or more thereof. In some embodiments, the second salt may include lithium 4,5-dicyano-2-(trifluoromethyl)imidazol-1-ide (LiTDI). In some embodiments, the second salt may include lithium difluoro(oxalato)borate (LiDFOB). In some embodiments, the second salt may include lithium bis(oxalato)borate (LiBOB).

In any of the above embodiments, the electrolyte may further include Li₂(B₁₂X_{12-q}Hₐ), Li₂(B₁₀X_{10-q′}H_{q′}), or a mixture of any two or more thereof, wherein X is independently at each occurrence a halogen, q is an integer from 0 to 12, and q′ is an integer from 0 to 10.

As noted above, the electrolytes include a lithium sulfonylimide, a lithium sulfonate, or a mixture of any two or more thereof. The lithium sulfonylimide or lithium sulfonate may be present in the electrolyte from about 0.05 wt % to about 5 wt %. In some embodiments, the lithium sulfonylimide or lithium sulfonate may be present in the electrolyte from about 0.1 M to about 2 M. Where the electrolyte includes the lithium sulfonylimide it may be a compound represented as formula:

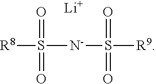

In the above Formula, R⁸ and R⁹ may be individually an alkyl group. Illustrative alkyl groups includes, but are not limited to, groups of formula CₙHₓF_{y}, CH₂CₙHₓF_{y}, CH₂OCₙHₓF_{y}, or CF₂OCₙHₓF_{y}, wherein n is 1-5, x is 0 to 10, and y is 1 to 11. Illustrative alkyl groups include, but are not limited to, —CH₃, —CH₂CH₃. —CH₂CH₂CH₃, —CH(CH₃)₂, —CH₂CH₂CH₂CH₃, —CFH₂; —CF₂H; —CF₃; —CF₂CF₃; —CF₂CHF₂; —CF₂CH₃; —CF₂CH₂F; —CHFCF₃; —CHFCHF₂; —CHFCH₃; —CHFCH₂F; —CH₂CF₃; —CH₂CHF₂; —CH₂CH₂F; —CF(CF₃)₂; —CH(CF₃)₂; —CF₂CF₂CF₃; —CF₂CF₂CHF₂; —CF₂CF₂CH₃; —CF₂CF₂CH₂F; —CH₂CF₂CF₃; —CH₂CF₂CHF₂; —CH₂CF₂CH₃; —CH₂CF₂CH₂F; —CHFCF₂CF₃; —CHFCF₂CHF₂; —CHFCF₂CH₃; —CHFCF₂CH₂F; —CF₂CH₂CF₃; —CF₂CH₂CHF₂; —CF₂CH₂CH₃; —CF₂CH₂CH₂F; —CF₂CHFCF₃; —CF₂CHFCHF₂; —CF₂CHFCH₃; —CF₂CHFCH₂F; —CHFCHFCF₃; —CHFCHFCHF₂; —CHFCHFCH₃; —CHFCHFCH₂F; CH₂CH₂CF₃; —CH₂CH₂CHF₂; —CH₂CH₂CH₂F; —CF₂CF₂CF₂CF₃; —CF₂CF₂CF₂CH₃; —CF₂CF₂CF₂CHF₂; —CF₂CF₂CF₂CH₂F; —CH₂CF₂CF₂CF₃; —CH₂CF₂CF₂CH₃; —CH₂CF₂CF₂CHF₂; —CH₂CF₂CF₂CH₂F; —CHFCF₂CF₂CF₃; —CHFCF₂CF₂CH₃; —CHFCF₂CF₂CHF₂; —CHFCF₂CF₂CH₂F; —CF₂CH₂CF₂CF₃; —CF₂CH₂CF₂CH₃; —CF₂CH₂CF₂CHF₂; —CF₂CH₂CF₂CH₂F; —CF₂CHFCF₂CF₃; —CF₂CHFCF₂CH₃; —CF₂CHFCF₂CHF₂; —CF₂CHFCF₂CH₂F; —CHFCHFCF₂CF₃; —CHFCHFCF₂CH₃; —CHFCHFCF₂CHF₂; —CHFCHFCF₂CH₂F; —CH₂CH₂CF₂CF₃; —CH₂CH₂CF₂CH₃; —CH₂CH₂CF₂CHF₂; —CH₂CH₂CF₂CH₂F; —CF₂CF₂CF₂CF₂CF₃; —CH₂CF₂CF₂CF₂CF₃; —CF₂CF₂CF₂ CF₂CHF₂; —CH₂CF₂CF₂CF₂CHF₂; —CF₂OCFH₂; —CF₂OCF₂H; —CF₂OCF₃; —CF₂OCF₂CF₃; —CF₂OCF₂CHF₂; —CF₂OCF₂CH₃; —CF₂OCF₂CH₂F; —CF₂OCHFCF₃; —CF₂OCHFCHF₂; —CF₂OCHFCH₃; —CF₂OCHFCH₂F; —CF₂OCH₂CF₃; —CF₂OCH₂CHF₂; —CF₂OCH₂CH₂F; —CH₂OCFH₂; —CH₂OCF₂H; —CH₂OCF₃; —CH₂OCF₂CF₃; —CH₂OCF₂CHF₂; —CH₂OCF₂CH₃; —CH₂OCF₂CH₂F; —CH₂OCHFCF₃; —CH₂OCHFCHF₂; —CH₂OCHFCH₃; —CH₂OCHFCH₂F; —CH₂OCH₂CF₃; —CH₂OCH₂CHF₂; —CH₂OCH₂CH₂F; —CHFOCFH₂; —CHFOCF₂H; —CHFOCF₃; —CHFOCF₂CF₃; —CHFOCF₂CHF₂; —CHFOCF₂CH₃; —CHFOCF₂CH₂F; —CHFOCHFCF₃; —CHFOCHFCHF₂; —CHFOCHFCH₃; —CHFOCHFCH₂F; —CHFOCH₂CF₃; —CHFOCH₂CHF₂; or —CHFOCH₂CH₂F. In some embodiments, the lithium sulfonimide is lithium bis-fluoromethanesulfonimide (LiFSI), lithium bis(trifluoromethanesulfonyl) imide (LiTFSI), lithium bis(perfluoroethanesulfonyl) imide (LiBETI), lithium methanesulfonamide, or a mixture of any two or more thereof.

Where the electrolyte includes the lithium sulfonate it may be a compound represented as formula:

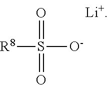

In the above formula, R⁸ may be an alkyl group. Illustrative alkyl groups includes, but are not limited to, groups of formula CₙHₓF_{y}, CH₂CₙHₓF_{y}, CH₂OCₙHₓF_{y}, or CF₂OCₙHₓF_{y}, wherein n is 1-5, x is 0 to 10, and y is 1 to 11. Illustrative alkyl groups include, but are not limited to, —CH₃, —CH₂CH₃. —CH₂CH₂CH₃, —CH(CH₃)₂, —CH₂CH₂CH₂CH₃, —CFH₂; —CF₂H; —CF₃; —CF₂CF₃; —CF₂CHF₂; —CF₂CH₃; —CF₂CH₂F; —CHFCF₃; —CHFCHF₂; —CHFCH₃; —CHFCH₂F; —CH₂CF₃; —CH₂CHF₂; —CH₂CH₂F; —CF(CF₃)₂; —CH(CF₃)₂; —CF₂CF₂CF₃; —CF₂CF₂CHF₂; —CF₂CF₂CH₃; —CF₂CF₂CH₂F; —CH₂CF₂CF₃; —CH₂CF₂CHF₂; —CH₂CF₂CH₃; —CH₂CF₂CH₂F; —CHFCF₂CF₃; —CHFCF₂CHF₂; —CHFCF₂CH₃; —CHFCF₂CH₂F; —CF₂CH₂CF₃; —CF₂CH₂CHF₂; —CF₂CH₂CH₃; —CF₂CH₂CH₂F; —CF₂CHFCF₃; —CF₂CHFCHF₂; —CF₂CHFCH₃; —CF₂CHFCH₂F; —CHFCHFCF₃; —CHFCHFCHF₂; —CHFCHFCH₃; —CHFCHFCH₂F; CH₂CH₂CF₃; —CH₂CH₂CHF₂; —CH₂CH₂CH₂F; —CF₂CF₂CF₂CF₃; —CF₂CF₂CF₂CH₃; —CF₂CF₂CF₂CHF₂; —CF₂CF₂CF₂CH₂F; —CH₂CF₂CF₂CF₃; —CH₂CF₂CF₂CH₃; —CH₂CF₂CF₂CHF₂; —CH₂CF₂CF₂CH₂F; —CHFCF₂CF₂CF₃; —CHFCF₂CF₂CH₃; —CHFCF₂CF₂CHF₂; —CHFCF₂CF₂CH₂F; —CF₂CH₂CF₂CF₃; —CF₂CH₂CF₂CH₃; —CF₂CH₂CF₂CHF₂; —CF₂CH₂CF₂CH₂F; —CF₂CHFCF₂CF₃; —CF₂CHFCF₂CH₃; —CF₂CHFCF₂CHF₂; —CF₂CHFCF₂CH₂F; —CHFCHFCF₂CF₃; —CHFCHFCF₂CH₃; —CHFCHFCF₂CHF₂; —CHFCHFCF₂CH₂F; —CH₂CH₂CF₂CF₃; —CH₂CH₂CF₂CH₃; —CH₂CH₂CF₂CHF₂; —CH₂CH₂CF₂CH₂F; —CF₂CF₂CF₂CF₂CF₃; —CH₂CF₂CF₂CF₂CF₃; —CF₂CF₂CF₂ CF₂CHF₂; —CH₂CF₂CF₂CF₂CHF₂; —CF₂OCFH₂; —CF₂OCF₂H; —CF₂OCF₃; —CF₂OCF₂CF₃; —CF₂OCF₂CHF₂; —CF₂OCF₂CH₃; —CF₂OCF₂CH₂F; —CF₂OCHFCF₃; —CF₂OCHFCHF₂; —CF₂OCHFCH₃; —CF₂OCHFCH₂F; —CF₂OCH₂CF₃; —CF₂OCH₂CHF₂; —CF₂OCH₂CH₂F; —CH₂OCFH₂; —CH₂OCF₂H; —CH₂OCF₃; —CH₂OCF₂CF₃; —CH₂OCF₂CHF₂; —CH₂OCF₂CH₃; —CH₂OCF₂CH₂F; —CH₂OCHFCF₃; —CH₂OCHFCHF₂; —CH₂OCHFCH₃; —CH₂OCHFCH₂F; —CH₂OCH₂CF₃; —CH₂OCH₂CHF₂; —CH₂OCH₂CH₂F; —CHFOCFH₂; —CHFOCF₂H; —CHFOCF₃; —CHFOCF₂CF₃; —CHFOCF₂CHF₂; —CHFOCF₂CH₃; —CHFOCF₂CH₂F; —CHFOCHFCF₃; —CHFOCHFCHF₂; —CHFOCHFCH₃; —CHFOCHFCH₂F; —CHFOCH₂CF₃; —CHFOCH₂CHF₂; or —CHFOCH₂CH₂F. In some embodiments, the lithium sulfonate is lithium trifluoromethanesulfonate, lithium methanesulfonate, or a mixture of any two or more thereof.

The solvent of the electrolyte is an aprotic solvent that may be a linear carbonate, an ether, a cyclic carbonate, an amide, an ester, a nitrile, a cyclic ester, a sulfone, or an ionic liquid. The electrolyte may include gelling materials such that an aprotic gel is present as well. In some embodiments, the aprotic solvent may include a cation that is a pyrrolidinium-based ionic liquid, a piperidinium-based ionic liquid, a imidazolium-based ionic liquid, an ammonium-based ionic liquid, a phosphonium-based ionic liquid, a cyclic phosphonium-based ionic liquid, or a sulfonium-based ionic liquid. The ionic liquids may an anion that is N(CF₃SO₂)₂⁻, N(FSO₂)₂⁻, N(CF₃CF₂SO₂)₂⁻, C(CF₃SO₂)₃⁻, CF₃SO₃⁻, CF₃CO₂⁻, N(CN)₂⁻, or C₂F₅CO₂⁻. Illustrative ionic liquids include, but are not limited to, 1-ethyl-3-methyl-imidazolium bis(trifluoromethanesulfonyl)imide, 1-ethyl-3-methyl-imidazolium bis(fluorosulfonyl)imide, 1-ethyl-2,3-dimethyl-imidazolium bis(trifluoromethanesulfonyl)imide, 1-ethyl-2,3-dimethyl-imidazolium bis(fluorosulfonyl)imide, 1-methyl-3-ethyl-imidazolium bis(trifluoromethanesulfonyl)imide, 1-methyl-3-ethyl-imidazolium bis(fluorosulfonyl)imide, 1-ethyl-3-(2-methoxyethoxymethyl)-1H-imidazol-3-ium bis(trifluoromethanesulfonyl)imide, 1-ethyl-3-(2-methoxyethoxymethyl)-1H-imidazol-3-ium bis(fluorosulfonyl)imide, 1-n-butyl-3-methyl-imidazolium bis(trifluoromethanesulfonyl)imide, 1-n-butyl-3-methyl-imidazolium bis(fluorosulfonyl)imide, 3-ethyl-1-(2-methoxyethyl)-1H-imidazol-3-ium bis(trifluoromethanesulfonyl)imide, 3-ethyl-1-(2-methoxyethyl)-1H-imidazol-3-ium bis(fluorosulfonyl)imide; pyrrolidinium salts such as 1-butyl-1-methylpyrrolidinium bis(trifluoromethanesulfonyl)imide, 1-butyl-1-methylpyrrolidinium bis(fluorosulfonyl)imide, 1-ethyl-1-methylpyrrolidinium bis(trifluoromethanesulfonyl)imide, 1-ethyl-1-methylpyrrolidinium bis(fluorosulfonyl)imide, 1-methyl-1-propylpyrrolidinium bis(trifluoromethanesulfonyl)imide, 1-methyl-1-propylpyrrolidinium bis(fluorosulfonyl)imide, 1-(2-methoxyethyl)-1-ethylpyrrolidinium bis(trifluoromethanesulfonyl)imide, 1-(2-methoxyethyl)-1-ethylpyrrolidinium bis(fluorosulfonyl)imide; piperidinium salts such as 1-butyl-1-methylpiperidinium bis(trifluoromethanesulfonyl)imide, 1-butyl-1-methylpiperidinium bis(fluorosulfonyl)imide, 1-methyl-1-propyl piperidinium bis(trifluoromethanesulfonyl)imide, 1-methyl-1-propyl piperidinium bis(fluorosulfonyl)imide, 1-(2-methoxyethyl)-1-ethylpiperidinium bis(trifluoromethanesulfonyl)imide, 1-(2-methoxyethyl)-1-ethylpiperidinium bis(fluorosulfonyl)imide; phosphonium salts such as triethyl(2-methoxyethyl)phosphonium bis(trifluoromethanesulfonyl)imide, triethyl(2-methoxyethyl)phosphonium bis(fluorosulfonyl)imide, tripropyl(2-methoxyethyl)phosphonium bis(trifluoromethanesulfonyl)imide, tripropyl(2-methoxyethyl)phosphonium bis(fluorosulfonyl)imide, tributyl(2-methoxyethyl)phosphonium bis(trifluoromethanesulfonyl)imide, tributyl(2-methoxyethyl)phosphonium bis(fluorosulfonyl)imide, tetraethylphosphonium bis(trifluoromethanesulfonyl)imide, tetraethylphosphonium bis(fluorosulfonyl)imide, tetrabutylphosphonium bis(trifluoromethanesulfonyl)imide, tetrabutylphosphonium bis(fluorosulfonyl)imide, tributylmethylphosphonium bis(trifluoromethanesulfonyl)imide, tributylmethylphosphonium bis(fluorosulfonyl)imide, triethylbutylphosphonium bis(trifluoromethanesulfonyl)imide, triethylbutylphosphonium bis(fluorosulfonyl)imide, or a mixture of any two or more thereof.

In some embodiments, the aprotic solvent may be an organic carbonate, fluorinated carbonate, ether, fluorinated ether, glyme, sulfone, organic sulfate, ester, cyclic ester, fluorinated ester, nitrile, amide, dinitrile, fluorinated amide, carbamate, fluorinated carbamate, or a cyanoester. Illustrative aprotic solvents include, but are not limited to, ethylene carbonate, fluoroethylene carbonate, 4-(trifluoromethyl)-1,3-dioxolan-2-one, propylene carbonate, dimethyl carbonate, ethyl methyl carbonate, diethyl carbonate, methyl propyl carbonate, ethyl propyl carbonate, dipropyl carbonate, bis(trifluoroethyl) carbonate, bis(pentafluoropropyl) carbonate, trifluoroethyl methyl carbonate, pentafluoroethyl methyl carbonate, trifluoroethyl ethyl carbonate, heptafluoropropyl ethyl carbonate, hexafluoroisopropyl methyl carbonate, pentafluoroethyl ethyl carbonate, pentafluorobutyl methyl carbonate, pentafluorobutyl ethyl carbonate, dimethoxyethane, triglyme, dimethyl ether, diglyme, tetraglyme, dimethyl ethylene carbonate, ethyl acetate, trifluoroethyl acetate, ethyl methyl sulfone, sulfolane, methyl isopropyl sulfone, butyrolactone, acetonitrile, succinonitrile, methyl 2-cyanoacetate, N,N-dimethylacetamide, 2,2,2-trifluoro-N,N-dimethylacetamide, methyl dimethylcarbamate, 2,2,2-trifluoroethyl dimethylcarbamate, and mixtures of any two or more thereof.

Any of the above lithium ion batteries may be a secondary lithium ion battery.

In the lithium ion batteries described above, the cathode is a high voltage cathode. In some embodiments, this may include a cathode active material that is a spinel, an olivine, a carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCOₗMe²_{y′}O_{2-z′}F_{z′}, VO₂, or E_{x″}F₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; F is Ti, V, Cr, Fe, or Zr; wherein 0≤x≤0.3; 0≤y≤0.5; 0≤z≤0.5; 0<m≤2; 0<n≤2; 0≤x′≤0.4; 0<α≤1; 0≤β≤1; 0≤γ≤1; 0≤h≤1; 0≤k≤1; 0≤1≤1; 0≤y′≤0.4; 0≤z′≤0.4; and 0≤x″≤3; with the provisos that at least one of h, k and 1 is greater than 0, and at least one of x, y and z is greater than 0. In some embodiments, the cathode active material includes Li_{1+W}MnₓNi_{y}Co_{z}O₂ wherein w, x, y, and z satisfy the relations 0<w<1, 0≤x<1, 0≤y<1, 0≤z<1, and x+y+z=1. In some embodiments, the cathode active material includes LiMnₓNi_{y}O₄ wherein x and y satisfy the 0≤x<2, 0≤y<2, and x+y=2. In some embodiments, the positive electrode includes LiMnₓNi_{y}O₄ wherein x and y satisfy the 0≤x<2, 0≤y<2, and x+y=2. In some embodiments, the positive electrode includes xLi₂MnO₃.(1-x)LiMO₂ is wherein 0≤x<2. In some embodiments, the cathode includes a cathode active material that is LiMn_{0.5}Ni_{0.5}O₂, LiCoO₂, LiNiO₂, LiNi₁₋ₓCo_{y}Mn_{z}O₂, or a combination of any two or more thereof. In some embodiments, the cathode includes a cathode active material that is LiNi_{α}Mn_{β}Co_{γ}O₂, NMC111, NMC532, NMC622, NMC811, or a Ni-rich layer material such as Li_{1+x′}NiₕMnₖCOₗMe²_{y′}O_{2-z′}F_{z′}, where 0≤h≤1.

The cathode may be stabilized by surface coating the active particles with a material that can neutralize acid or otherwise lessen or prevent leaching of the transition metal ions. Hence the cathodes can also comprise a surface coating of a metal oxide or fluoride such as ZrO₂, TiO₂, ZnO₂, WO₃, Al₂O₃, MgO, SiO₂, SnO₂, AlPO₄, Al(OH)₃, AlF₃, ZnF₂, MgF₂, TiF₄, ZrF₄, a mixture of any two or more thereof, of any other suitable metal oxide or fluoride. The coating may be applied to a carbon coated cathode.

The cathode may be further stabilized by surface coating the active particles with polymer materials. Examples of polymer coating materials include, but not limited to, polysiloxanes, polyethylene glycol, or poly(3,4-ethylenedioxythiophene) polystyrene sulfonate, a mixture of any two or more polymers.

The electrodes (i.e., the cathode and/or the anode) may also include a conductive polymer. Illustrative conductive polymers include, but not limited to, polyaniline, polypyrrole, poly(pyrrole-co-aniline), polyphenylene, polythiophene, polyacetylene, polysiloxane, or polyfluorene.

In the lithium ion batteries described above, the anode may include natural graphite, synthetic graphite, hard carbon, amorphous carbon, soft carbon, mesocarbon microbeads, acetylene black, Ketjen black, carbon black, mesoporous carbon, porous carbon matrix, carbon nanotube, carbon nanofiber, graphene, silicon microparticle, silicon nanoparticle, silicon-carbon composite, tin microparticle, tin nanoparticle, tin-carbon composite, silicon-tin composite, phosphorous-carbon composites, lithium titanium oxide, or lithium metal. In some embodiments, the anode includes lithium and graphite.

In the lithium ion batteries described above, the cathode and/or anode may include a binder holding the active material, or other electrode materials in contact with the current collector. Illustrative binders include, but are not limited to, polyvinylidene difluoride (PVDF), poly(acrylic acid) (PAA), lithiated PAA, polyimide (PI), polyacrylonitrile (PAN), styrene-butadiene rubber (SBR), carboxymethyl cellulose (CMC), and combinations of any two or more thereof.

In the lithium ion batteries described above, the cathode includes a current collector that is aluminum or stainless steel. The anode may include a current collector that is copper, nickel, or titanium.

In the lithium ion batteries described above, the separator is a porous separator that is used to separate the cathode from the anode and prevent, or at least minimize, short-circuiting in the device. The separator may be a polymer or ceramic or mixed separator. The separator may include, but is not limited to, polypropylene (PP), polyethylene (PE), trilayer (PP/PE/PP), paper, or polymer films that may optionally be coated with alumina-based ceramic particles.

The present invention, thus generally described, will be understood more readily by reference to the following examples, which are provided by way of illustration and are not intended to be limiting of the present invention.

### EXAMPLES

### Example 1

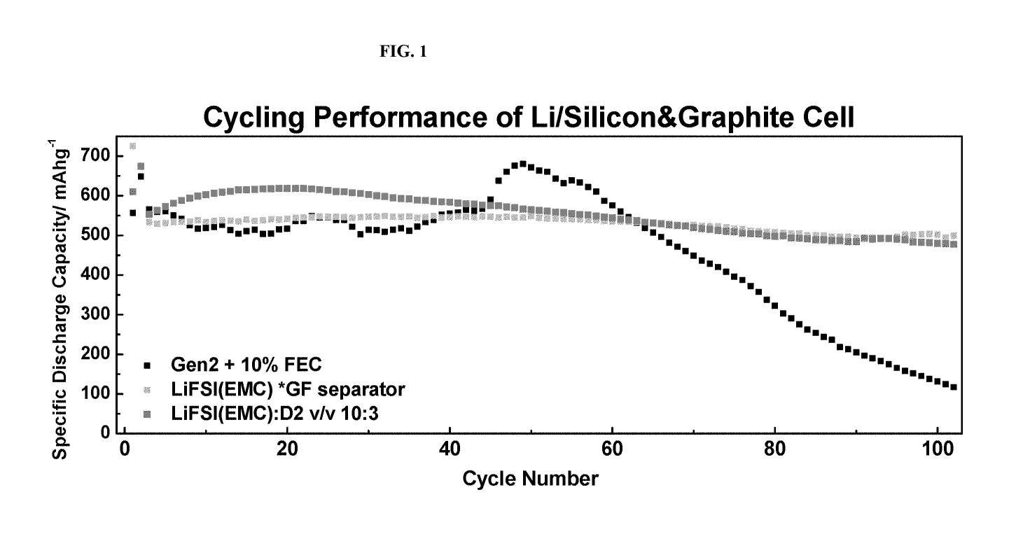

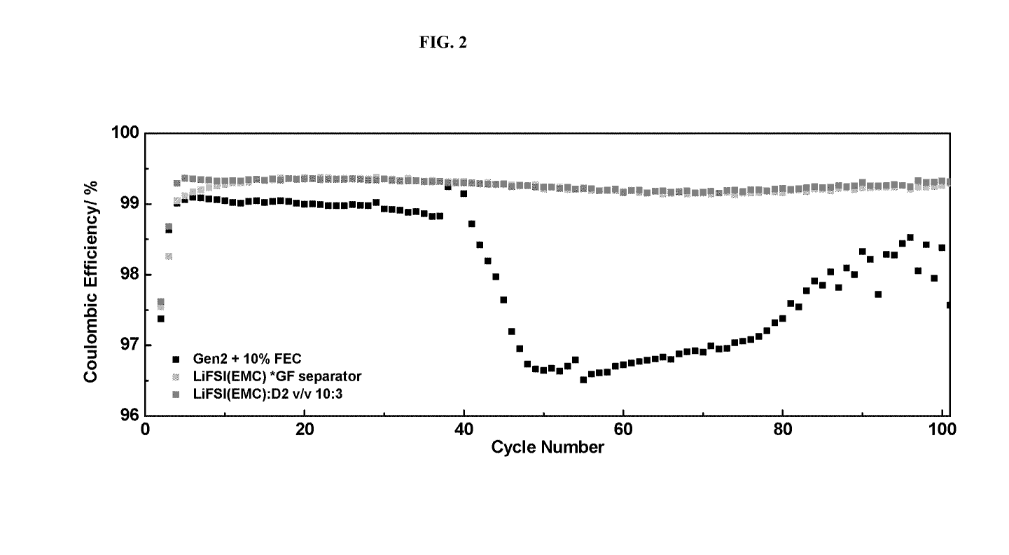

FIG. 1 shows the discharge capacity of a Li/Silicon@graphite half-cells using 1.2M LiPF₆ EC/EMC (3:7) with 10 wt % FEC electrolyte, LiFSI/EMC (1:1 in molar ratio) electrolyte and LiFSI/EMC 1:1 in molar ratio with 30% D2 as the co-solvent electrolyte. The Li/Silicon@graphite is a composite anode with 15% Si and 73% graphite. The cells were cycled from 0.05 V to 1.5 V at the rate of C/2. The cell using baseline electrolyte and 10% FEC as additive shows obvious capacity degradation than the LiTFSI based cells. That is because a high concentration LiTFSI salt can form a good SEI on the Si anode to overcome the losing of Li ion in the system. FIG. 2 shows the Coulombic efficiency of the above cells. The cells with LiFSI salt based electrolyte have a Coulombic efficiency of greater than 99%. However, the cell with baseline electrolyte and 10% FEC as additive shows much lower Coulombic efficiency, especially, the efficiency drop dramatically after 40 cycles.

### Example 2

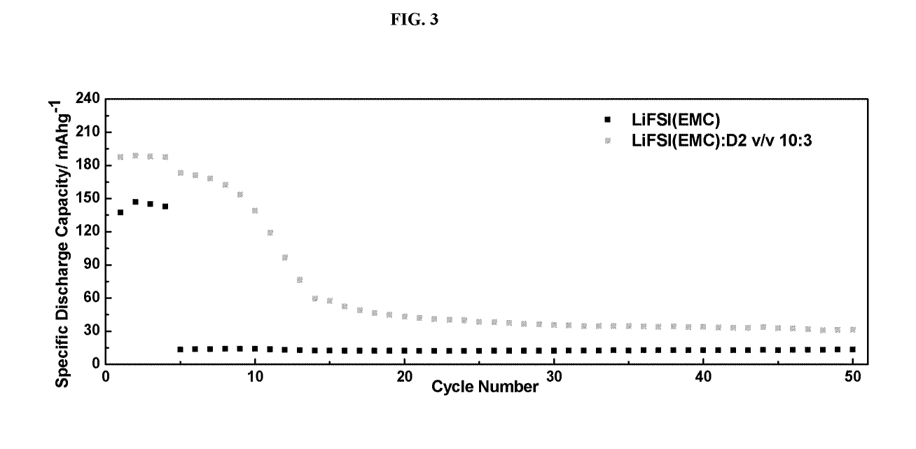

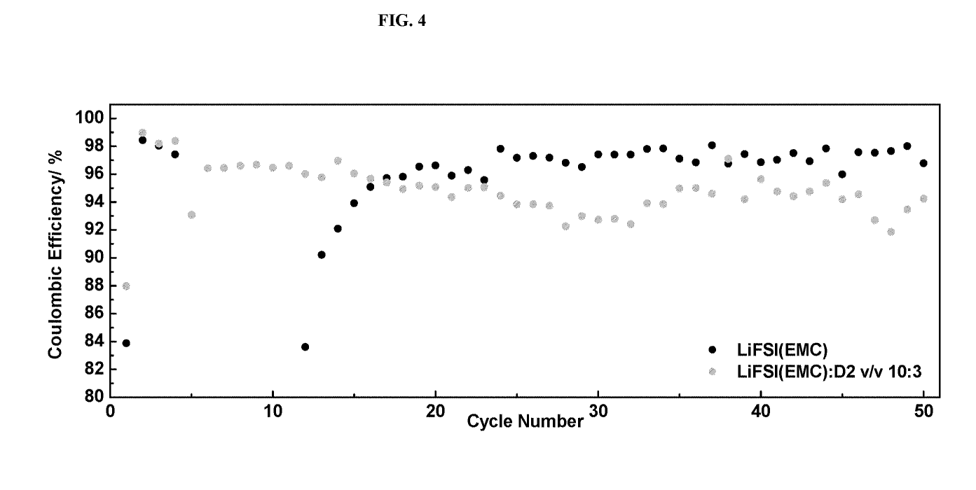

FIG. 3 illustrates the discharge capacity of LiNi_{0.6}Mn_{0.2}Co_{0.2}O₂/Li half-cells using LiFSI/EMC electrolyte (1:1 in molar ratio) and LiFSI/EMC (1:1 in molar ratio) with 30% 1,1,2,2-tetrafluoro-3-(1,1,2,2-tetrafluoroethoxy)propane (HFE) as the co-solvent electrolyte. The cells were cycled from 2.8 V to 4.4 V at the rate of C/3. Both cells show server capacity degradation, which is because the LiFSI cannot passivate the Al current collector under the high upper cutoff voltage. As a result, the Al current collector was corroded by the electrolyte continuously. Furthermore, the corrosion resulted in a drop in capacity during cycling. FIG. 4 illustrates the Coulombic efficiency of the above cells. The cells with LiFSI salt in the electrolyte show a low Coulombic efficiency of about 98%, due to the corrosion of the Al current collector.

### Example 3

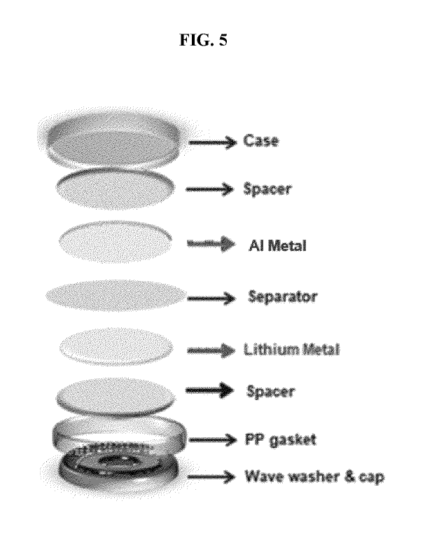

FIG. 5 is a schematic drawing of a Li/Al cell used for the potentiostatic hold experiments described herein. The main structure of the cell is a 2032 type coin cell with anode/cathode cap, PP gasket, spring and two spacers. Here, we used Li metal as the counter electrode, an Al current collector as the working electrode, and Celgard 2325 as the separator.

### Example 4

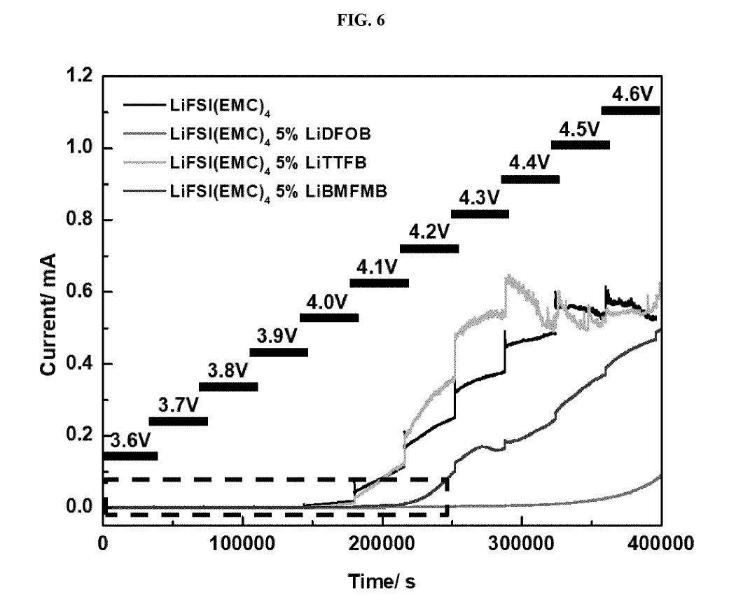

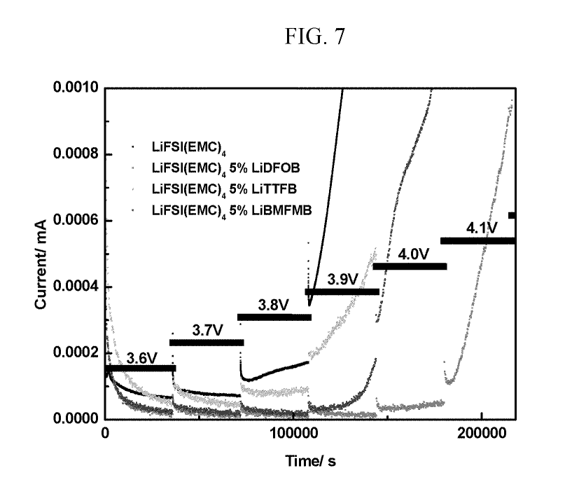

FIG. 6 illustrates the chronoamperogram of the Al/Li half-cell potentiostatic hold experiments for a LiFSI:EMC (1:4 molar ratio) electrolyte without/with different additives. A dramatic increase of the leakage current was observed above 4.0V for the cell with LiFSI:EMC (1:4 molar ratio) electrolyte and LiFSI:EMC (1:4 molar ratio) with 5% LiTTFB electrolyte. The Al current collector corroded under the high voltage. For the cell cycled in LiFSI:EMC (1:4 molar ratio) with 5% LiBMFMB additive electrolyte, the leakage current was increased to 4.1V, a slightly higher voltage. That means the 5% LiBMFMB passivated the Al current collector slightly, but it did not prove efficient in doing so. For the cell with LiFSI:EMC (1:4 molar ratio) and 5% LiDFOB additive electrolyte, a comparable low leakage current can be observed even at 4.5V upper cutoff voltage. It can be concluded that the Al current collector can be passivated better with LiDFOB than other additives. FIG. 7 shows a chronoamperogram of the Al/Li half-cell potentiostatic hold experiments result in LiFSI:EMC (1:4 molar ratio) electrolyte without/with different additive under the voltage range from 3.6V to 4.1V and a low current region (below 0.001 mA). Based on the testing results, the cell without any additive shows the lowest stability and the stabilities of the additives are in the order LiDFOB>LiBMFMB>LiTTFB.

### Example 5

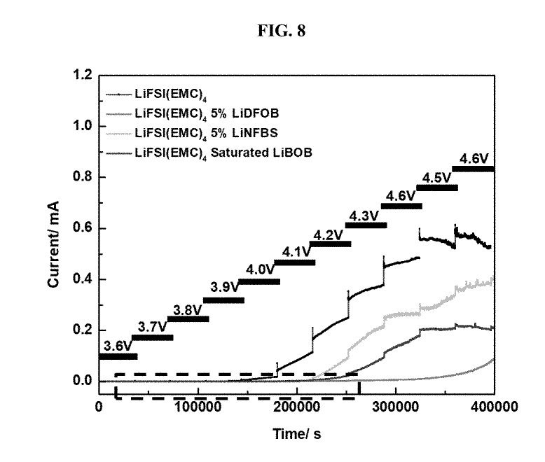

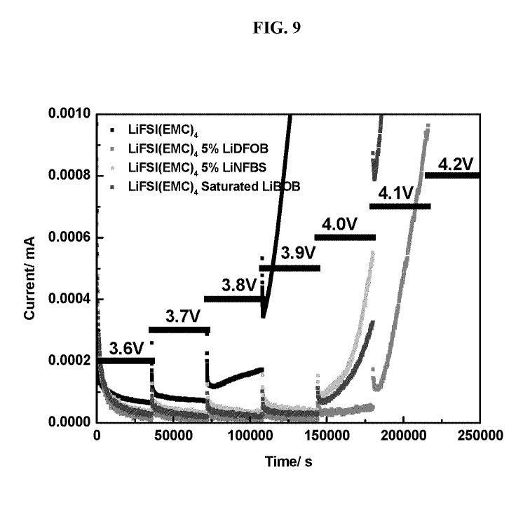

FIG. 8 is a chronoamperogram of the Al/Li half-cell potentiostatic hold experiments result in LiFSI:EMC (1:4 molar ratio) electrolyte without/with 5% LiDFOB, LiNFBS or saturated LiBOB as the additive under upper cutoff voltage from 3.6V to 4.6V. A dramatic increase in the leakage current was observed after 4.0V for the cell with LiFSI:EMC (1:4 molar ratio) electrolyte and LiFSI:EMC (1:4 molar ratio) with 5% LiNFBS electrolyte. The high current was caused by the Al current collector corrosion under that voltage. For the cell cycled in LiFSI:EMC (1:4 molar ratio) with saturated LiBOB additive electrolyte, the leakage current increased from 4.1V, a slightly higher voltage than previous cells. That means the saturated LiBOB can passivate the Al current collector partly, but not such efficient. For the cell with LiFSI:EMC (1:4 molar ratio) and 5% LiDFOB additive electrolyte, a low leakage current can be observed even at 4.5V upper cutoff voltage. It can be concluded that the Al current collector can be passivated better with LiDFOB than other additives. FIG. 9 is a chronoamperogram of the Al/Li half-cell potentiostatic hold experiments result in LiFSI:EMC (1:4 molar ratio) electrolyte without/with different additive under the voltage range from 3.6V to 4.2V and a low current region (below 0.001 mA). Based on the testing results, the cell without any additive shows the lowest stability and the stabilities of the additives are in the order LiDFOB>LiBOB>LiNFBS.

### Example 6

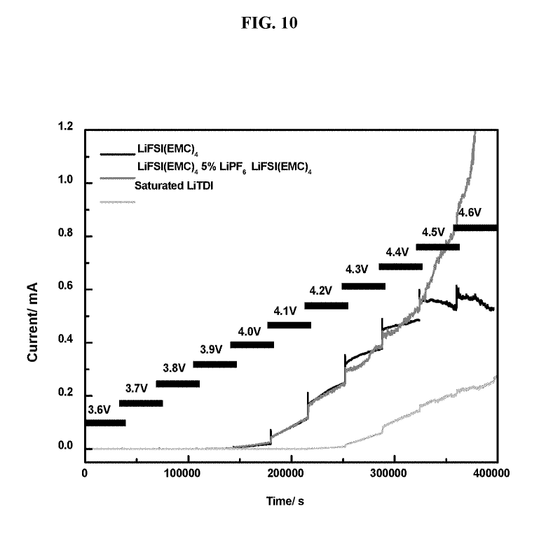

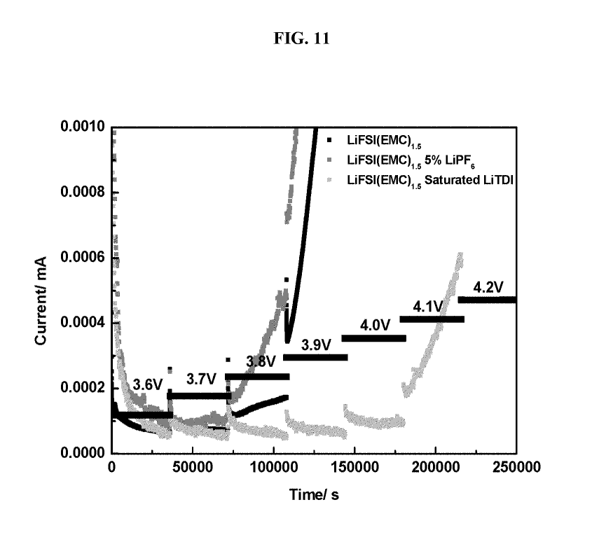

FIG. 10 is a chronoamperogram of the Al/Li half-cell potentiostatic hold experiments result in LiFSI:EMC (1:4 molar ratio) electrolyte without/with 5% LiPF₆, or saturated LiTDI as the additive under upper cutoff voltage from 3.6V to 4.6V, 10 hrs for each hold. A dramatic increasing of the leakage current was observed after 4.0V for the cell with LiFSI:EMC (1:4 molar ratio) electrolyte and LiFSI:EMC (1:4 molar ratio) with 5% LiPF₆ electrolyte. That high current was caused by the Al current collector corrosion under that voltage. For the cell cycled in LiFSI:EMC (1:4 molar ratio) with saturated LiTDI additive electrolyte, the leakage current was increased from 4.2V, a higher voltage than previous cells. That means the saturated LiTDI can passivate the Al current collector partly. FIG. 11 is the chronoamperogram of the Al/Li half-cell potentiostatic hold experiments result in LiFSI:EMC (1:4 molar ratio) electrolyte without/with different additive under the voltage range from 3.6V to 4.2V and a low current region (below 0.001 mA). Based on the testing results, the cell without any additive shows the lowest stability and the stabilities of the additives are in the order LiTDI>LiPF₆.

### Example 7

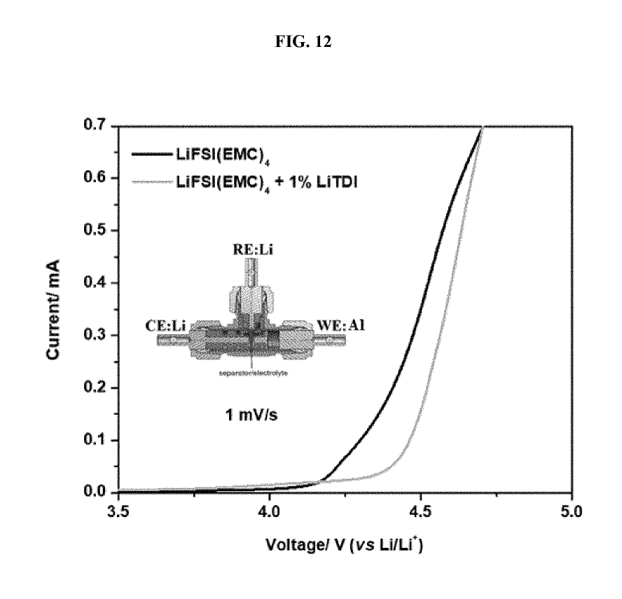

FIG. 12 illustrates linear sweep voltammograms of electrolytes LiFSI:EMC (1:4 molar ratio) electrolyte without/with 1% LiTDI as the additive by using a three-electrode system (Al working electrode, lithium counter electrode and lithium reference electrode). For LiFSI:EMC (1:4 molar ratio) electrolyte, the oxidation reaction was triggered at about 4.0V vs. Li. For LiFSI:EMC (1:4 molar ratio) electrolyte with 1% LiTDI, the oxidation reaction was triggered at about 4.3 V vs. Therefore, the LiTDI based electrolyte can better passivate the Al current collector.

### Example 8

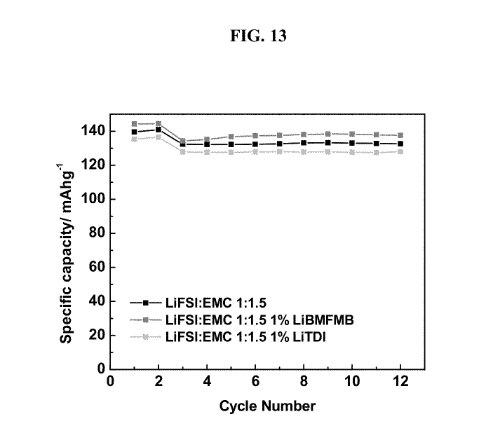

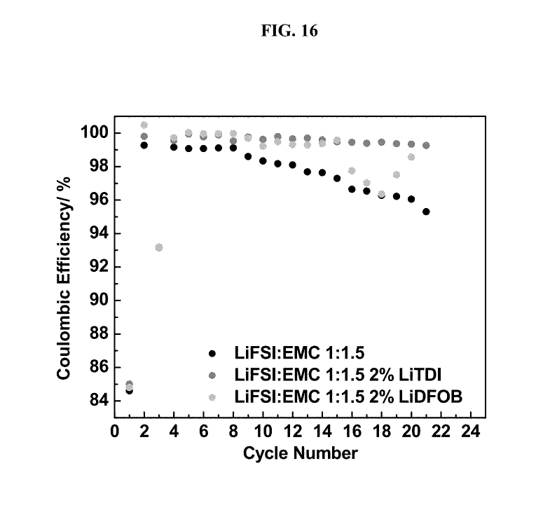

FIG. 13 illustrates the discharge capacity of the Li/NCM523 half-cell in the 2032 coin cells using LiFSI:EMC (1:1.5 molar ratio) electrolyte without/with 1% LiBMFMB or 1% LiTDI as additive. The cells were cycled from 3.0 V to 4.1 V at the rate of C/3. All three cells shown good capacity retention with in the first 12 cycles. FIG. 16 shows the Coulombic efficiency of the above cells. The cell without any additive shows the lowest Coulombic efficiency and the Coulombic efficiency of the additives are in the order LiTDI>LiBMFMB.

### Example 9

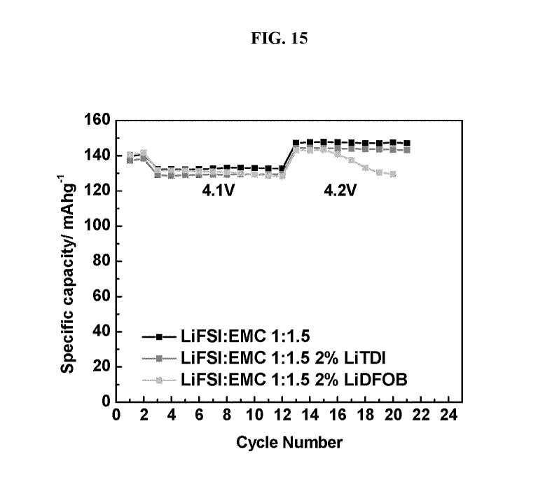

FIG. 15 shows the discharge capacity of the Li/NCM523 half-cell in the 2032 coin cells using in LiFSI:EMC (1:1.5 molar ratio) electrolyte without/with 2% LiTDI or 2% LiDFOB as additive. The cells were cycled from 3.0 V to 4.1V for the 1-10 cycles and 3.0-4.2V for the 11-21 cycles at the rate of C/3. Three cells show similar capacity retention under the 4.1 upper cutoff voltage range. At the 4.2V upper cutoff voltage, the cell with 2% LiDFOB show poor capacity retention compared to other cells. FIG. 16 illustrates the Coulombic efficiency of the above cells. The cell without the additive shows the lowest Coulombic efficiency and the Coulombic efficiency of the additives are in the order LiTDI>LiDFOB.

### Example 10

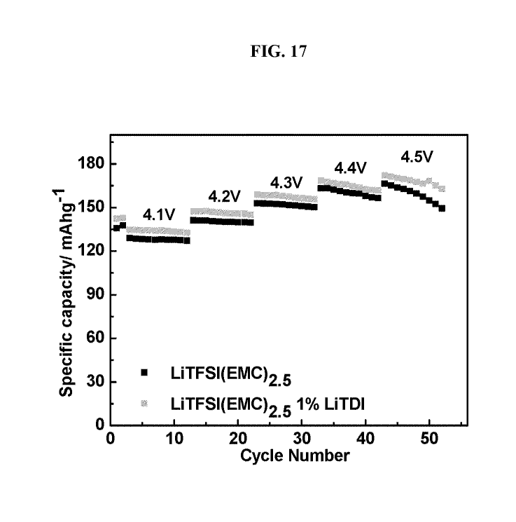

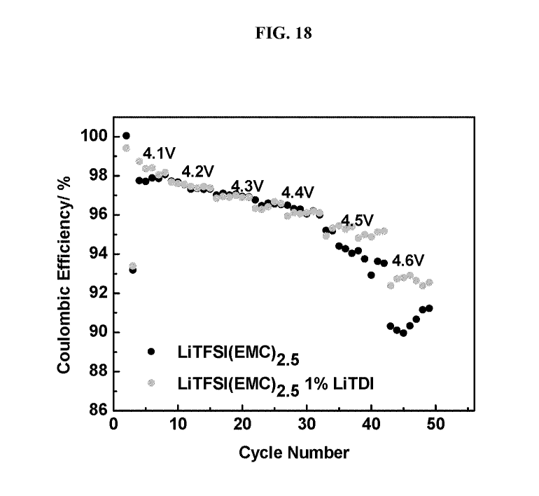

FIG. 17 illustrates the discharge capacity of a Li/NCM523 half-cell in a 2032 coin cell configuration using LiFSI:EMC (1:2.5 molar ratio) electrolyte without/with 1% LiTDI as additive. The cells were cycled from 3.0V to different upper cutoff voltage, 4.1V-4.5V and 10 cycles for each voltage under the rate of C/3. Two cells show similar capacity retention till the upper cutoff voltage was higher than 4.4V. Under 4.5V upper cutoff voltage, the cell with 1% LiTDI shows better capacity retention than the cell without. FIG. 18 illustrates the Coulombic efficiency of the above cells. The two cells show similar Coulombic efficiency, however the upper cutoff voltage was higher than 4.4V. Under 4.5V and 4.6V upper cutoff voltage range, the cell with 1% LiTDI shows higher Coulombic efficiency than the cell without LiTDI.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A lithium ion battery comprising:
a cathode having a voltage of greater than 4.1 V v. Li/Li⁺ and an aluminum or stainless steel current collector;
an anode;
a separator; and
an electrolyte comprising:
a first salt that is a lithium sulfonylimide, a lithium sulfonate, a lithium sulfonylmethide, or a mixture of any two or more thereof, and the first salt is present in the electrolyte from about 0.1 M to about 2 M;
an aprotic solvent; and
a second salt which suppresses corrosion of the aluminum or stainless steel current collector;
wherein:
the second salt is present in the electrolyte from about 0.1 wt % to about 10 wt %; and
the second salt is a compound of Formula I, II, or III: 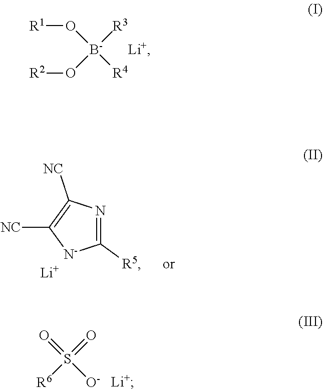
R¹ is alkyl, alkenyl, or alkynyl;
R² is alkyl, alkenyl, or alkynyl;
or R¹ and R² may join together to form a ring with the boron and oxygen atoms to which they are attached;
R³ is F, Cl, Br, I, alkyl, or O-alkyl;
R⁴ is F, Cl, Br, I, alkyl, or O-alkyl;
or R³ and R⁴ may join together to form a ring with the boron atom to which they are attached;
R⁵ is H, alkyl, alkenyl, alkynyl, or O-alkyl; and
R⁶ is H, alkyl, alkenyl, or alkynyl.

2. The lithium ion battery of claim 1, wherein any of the alkyl, alkenyl, or alkynyl groups are halogenated.

3. The lithium ion battery of claim 2, wherein any of the alkyl groups comprise a group of formula CₙHₓF_{y}, CH₂CₙHₓF_{y}, CH₂OCₙHₓF_{y}, or CF₂OCₙHₓF_{y}, wherein n is 1-5, x is 0 to 10, and y is 1 to 11.

4. The lithium ion battery of claim 1, wherein the second salt comprises a compound of Formula I, and wherein R¹ and R² are haloalkyl or they join together to form a ring; and R³ and R⁴ are F, O-haloalkyl, or they join together to form a ring.

5. The lithium ion battery of claim 1, wherein the second salt comprises a compound of Formula I, and is Li[B(O(CH₂)ₓCF₃)₄] where x is 1, 2, 3, 4, 5, or 6;

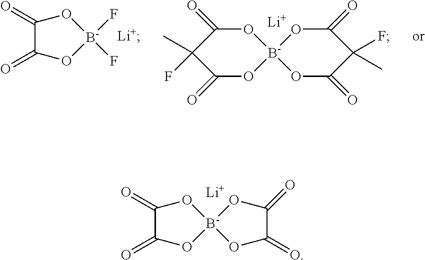

6. The lithium ion battery of claim 1, wherein the second salt comprises a compound of Formula II, and is

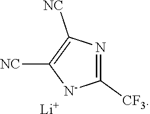 [SMILES: N#Cc1nc(C(F)(F)F)[n-]c1C#N ; [Li+]]

7. The lithium ion battery of claim 1, wherein the second salt comprises a compound of Formula III, and is 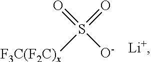
where x is 1, 2, 3, 4, 5, or 6.

8. The lithium ion battery of claim 1, wherein the electrolyte further comprises Li₂(B₁₂X_{12-q}Hₐ), Li₂(B₁₀X_{10-q′}H_{q′}), or a mixture of any two or more thereof, wherein X is independently at each occurrence a halogen, q is an integer from 0 to 12, and q′ is an integer from 0 to 10.

9. The lithium ion battery of claim 1, wherein the electrolyte is free of LiPF₆.

10. The lithium ion battery of claim 1, wherein the lithium sulfonylimide is present and is a compound of formula: 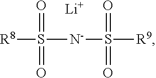
wherein R⁸ and R⁹ are individually F, alkyl, haloalkyl, aryl, haloaryl.

11. The lithium ion battery of claim 10, wherein the lithium sulfonimide is lithium bis-fluoromethanesulfonimide.

12. The lithium ion battery of claim 1, wherein the lithium sulfonate is present and is a compound of formula: 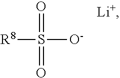
wherein R⁸ is F, alkyl, haloalkyl, aryl, haloaryl.

13. The lithium ion battery of claim 1, wherein the lithium sulfonylmethide is present and is a compound of formula: 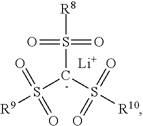
wherein R⁸, R⁹ and R¹⁰ are individually F, alkyl, haloalkyl, aryl, haloaryl.

14. The lithium ion battery of claim 1, wherein the aprotic solvent comprises a linear carbonate, an ether, a cyclic carbonate, an amide, an ester, a nitrile, a cyclic ester, a sulfone, an ionic liquid.

15. The lithium ion battery of claim 1, wherein the aprotic solvent comprises a pyrrolidinium-based ionic liquid, a piperidinium-based ionic liquid, a imidazolium-based ionic liquid, an ammonium-based ionic liquid, a phosphonium-based ionic liquid, a cyclic phosphonium-based ionic liquid, or a sulfonium-based ionic liquid.

16. The lithium ion battery of claim 1, wherein the electrolyte further comprises an aprotic gel polymer.

17. The lithium ion battery of claim 1 that is a lithium secondary battery.

18. The lithium cell of claim 1, wherein the cathode comprises a spinel, an olivine, a carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+xζ}NiₕMnₖCOₗMe²_{y′}O_{2-z′}F_{z′}, VO₂, or E_{x″}F₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; F is Ti, V, Cr, Fe, or Zr; wherein 0≤x≤0.3; 0≤y≤0.5; 0<z≤0.5; 0<m≤2; 0≤n≤2; 0≤x′≤0.4; 0<α≤1; 0<β≤1; 0<γ≤1; 0≤h≤1; 0≤k≤1; 0≤1≤1; 0≤y′≤0.4; 0≤z′≤0.4; and 0≤x″≤3; with the provisos that at least one of h, k and 1 is greater than 0, and at least one of x, y and z is greater than 0.

19. The lithium cell of claim 1, wherein the cathode comprises LiMn_{0.5}Ni_{0.5}O₂, LiCoO₂, LiNiO₂, LiNi₁₋ₓCo_{y}Mn_{z}O₂, or a combination of any two or more thereof.

20. The lithium cell of claim 1, wherein the anode comprises natural graphite, synthetic graphite, hard carbon, amorphous carbon, soft carbon, mesocarbon microbeads, acetylene black, Ketjen black, carbon black, mesoporous carbon, porous carbon matrix, carbon nanotube, carbon nanofiber, graphene, silicon microparticle, silicon nanoparticle, silicon-carbon composite, tin microparticle, tin nanoparticle, tin-carbon composite, silicon-tin composite, phosphorous-carbon composites, lithium titanium oxide, or lithium metal.
